(19) United States
(12) Patent Application Publication
(10) Pub. No.: US 2021/0363025 A1
(43) Pub. Date: Nov. 25, 2021

(54) SURFACE MODIFIED LAYERED DOUBLE HYDROXIDE

(71) Applicant: SCG Chemicals Co., Ltd., Bangkok (TH)

(72) Inventors: Anchalee Wongariyakawee, Bangkok (TH); Sarayout Hmuean-Prom, Bangkok (TH); Piyanuch Luangtriratana, Bangkok (TH); Kok Boon Heh, Bangkok (TH)

(21) Appl. No.: 17/051,265

(22) PCT Filed: May 10, 2019
(86) PCT No.: PCT/GB2019/051296

§ 371 Date: Oct. 28, 2020

(30) Foreign Application Priority Data
May 14, 2018 (EP) 18172128.3

(51) Int. Cl. C01F 7/00

(52) U.S. Cl. CPC C01F 7/004; C01P 2002/22; B82Y 30/00; C01P 2004/64; C01P 2006/32

(57) ABSTRACT

Processes for making surface-modified layered double hydroxides (LDHs) are disclosed, as well as surface-modified LDHs, and their uses in composite materials. The surface-modified LDHs of the invention are more hydrophobic than their unmodified analogues, which allows the surface-modified LDHs to be incorporated in a wide variety of materials, wherein the interesting functionality of LDHs may be exploited.

### INTRODUCTION

The present invention relates to surface modified layered double hydroxides, as well as to processes for making the surface modified layered double hydroxides, and their uses in composite materials.

### BACKGROUND OF THE INVENTION

Layered double hydroxides (LDHs) are a class of compounds which comprise two metal cations and have a layered structure. A review of LDHs is provided in Structure and Bonding; Vol 119, 2005 Layered Double Hydroxides ed. X Duan and D. G. Evans. The hydrotalcites, perhaps the most well-known examples of LDHs, have been studied for many years. LDHs can intercalate anions between the layers of the structure. WO 99/24139 discloses the use of LDHs to separate anions including aromatic and aliphatic anions.

Owing to the concentration of hydroxyl groups on their surface, conventionally-prepared LDHs are highly hydrophilic. As a consequence, conventionally-prepared LDHs often retain a considerable amount of water from the manufacturing process by which they were made.

The hydrophilicity of conventionally-prepared LDHs limits the extent to which they can be dispersed in organic solvents, thereby precluding their incorporation into a variety of materials wherein the interesting properties of LDH would be desirable. Attempts to address this by thermal treatment of the LDH to remove surface complexed water, may result in the formation of highly aggregated, “stone-like”, non-porous bodies with low specific surface areas of typically 5 to 15 m²/g.

A method of preparing LDHs with a specific surface area of at least 125 m²/g was reported (WO2015/144778), the method comprising slurrying a dispersion of a water-wet LDH in an aqueous-miscible organic (AMO) solvent, followed by recovery and drying of the so-called AMO-LDH. Nevertheless, such AMO-LDHs suffer from a high moisture uptake capacity compared with conventionally-prepared LDHs and as a result can be difficult to process and incorporate into composite materials.

The present invention was devised with the foregoing in mind.

### SUMMARY OF THE INVENTION

According to a first aspect of the present invention there is provided a process for forming a modified layered double hydroxide comprising the steps of:
a) providing a layered double hydroxide;
b) heating the layered double hydroxide to 110-200° C.; and
c) mixing the thermally-treated layered double hydroxide of step b) with a modifier, wherein the mixing is conducted in the presence of less than or equal to 50% by weight of a solvent, relative to the total weight of the layered double hydroxide and the modifier.

According to a further aspect of the present invention there is provided a modified layered double hydroxide obtainable, obtained or directly obtained by a process defined herein.

According to a further aspect of the present invention there is provided a composite material comprising a modified layered double hydroxide as defined herein dispersed throughout a polymer.

### DETAILED DESCRIPTION OF THE INVENTION

As discussed hereinbefore, the present invention provides a process for forming a modified layered double hydroxide comprising the steps of:
a) providing a layered double hydroxide;
b) heating the layered double hydroxide to 110-200° C.; and
c) mixing the thermally-treated layered double hydroxide of step b) with a modifier, wherein the mixing is conducted in the presence of less than or equal to 50% by weight of a solvent, relative to the total weight of the layered double hydroxide and the modifier.

The inventors have determined that the surface modification of conventionally-prepared LDHs is hindered by a number of factors. Principally, the presence of large amounts of water in the conventionally-prepared LDH significantly reduces the efficiency of the reaction between the surface modifying agent and the hydroxyl functional groups located on the surface of the LDH. In particular, rather than reacting with the available hydroxyl groups on the LDH, the surface modifying agent may react preferentially with the complexed water. Moreover, the presence of water is likely to give rise to an increased number of unwanted side-reactions, thus generating undesirable by-products which results in the generation of impure materials. Attempts to address this by thermal treatment of the conventionally-prepared LDH to remove complexed water may result in the formation of highly aggregated, “stone-like”, non-porous bodies having low specific surface area of generally 5 to 15 m²/g, but even as low as 1 m²/g.

A method of preparing LDHs with a specific surface area of at least 125 m²/g has been reported (WO2015/144778); the method comprises slurrying a dispersion of a water-wet LDH in an aqueous-miscible organic (AMO) solvent, followed by recovery and drying of the so-called AMO-LDH. Nevertheless, such AMO-LDHs suffer from a high moisture uptake capacity compared with conventionally-prepared LDHs and as a result can be difficult to process and incorporate into composite materials. Similarly, although conventionally-prepared LDHs can be subjected to grinding, milling or similar particle size reduction methods in order to increase their surface area for modification, this typically increases their moisture uptake capacity and makes subsequent processing difficult.

The inventors have now devised a means of successfully and flexibly modifying the surface properties of LDHs, thereby extending their interesting functionality to a wide array of applications. In particular, it has been discovered that carrying out a thermal treatment on the LDHs, followed by a mixing process with modifier carried out in the absence or near-absence of solvent, leads to modified LDHs having both higher densities, increased hydrophobicity and significantly reduced moisture uptake capacity. The process according to this invention also offers benefits in terms of scalability and environmental impact due to the avoidance of solvents.

The surface modified LDHs of the invention can be used in a variety of applications, wherein conventionally-prepared hydrophilic LDHs would be unsuitable.

In an embodiment, the layered double hydroxide provided in step a) has a specific surface area of at least 15 m²/g, for example at least 20 m²/g, such as at least 32 m²/g, preferably at least 50 m²/g, most preferably at least 75 m²/g. In an embodiment, the layered double hydroxide provided in step a) has a specific surface area of greater than 125 m²/g.

In an embodiment, the layered double hydroxide provided in step a) has a specific surface area in a range of 10-105 m²/g, preferably 10-40 m²/g, most preferably 20-40 m²/g. In an embodiment, the layered double hydroxide provided in step a) has a particle size (when measured in a-b plane) in a range of 30 nm-5 μm, preferably 50 nm-1 μm, most preferably 100 nm-1 μm. In an embodiment, the layered double hydroxide provided in step a) has a bulk density in a range of 0.1-0.6 g/ml, preferably 0.2-0.4 g/ml, most preferably 0.2-0.3 g/ml. In an embodiment, the layered double hydroxide provided in step a) has a tap density in a range of 0.2-0.7 g/ml, preferably 0.3-0.6 g/ml, most preferably 0.4-0.5 g/ml. In an embodiment, the layered double hydroxide provided in step a) has a moisture content less than 10%, preferably less than 5%, most preferably less than 3% w/w. In an embodiment, the layered double hydroxide provided in step a) has no impurity such as Fe, ZnO and Na₂O. In an embodiment, the primary particle of layered double hydroxide is platelet, which may agglomerate to form rosette shape. In an embodiment, the layered double hydroxide provided in step a) has a particle size distribution with D10 in a range of 0.1-2 μm, preferably 0.3-1.5 μm, most preferably 0.5-1 μm; D50 in a range of 1-5 μm, preferably 1-4 μm, most preferably 2-3 μm; and D90 in a range of 2-10 μm, preferably 2-7 μm, most preferably 3-5 μm.

In an embodiment, the layered double hydroxide provided in step a) is of formula (IA):

[M^{z+}₁₋ₓM′^{y+}ₓ(OH)₂]^{a+}(Xⁿ⁻)ₘ.bH₂O (IA)

wherein
M is at least one charged metal cation;
M′ is at least one charged metal cation different from M;
z is 1 or 2;
y is 3 or 4;
0<x<0.9;
0<b≤10;
X is at least one anion;
n is the charge on anion(s) X;
a is equal to z(1−x)+xy−2; and
m≥a/n.

In an embodiment, the layered double hydroxide provided in step a) is of formula (IB):

[M^{z+}₁₋ₓM′^{y+}ₓ(OH)₂]^{a+}(Xⁿ⁻)ₘ.bH₂O.c(L) (IB)

wherein
M is at least one charged metal cation;
M′ is at least one charged metal cation different from M;
z is 1 or 2;
y is 3 or 4;
0<x<0.9;
0<b≤10;
0<c≤10;
X is at least one anion;
n is the charge on anion(s) X;
a is equal to z(1−x)+xy−2;
m≥a/n; and
L is an organic solvent capable of hydrogen-bonding to water.

In an embodiment, in step a), a layered double hydroxide of formula (IA) or formula (IB) is provided wherein when z is 2, M is Mg, Zn, Fe, Ca, Sn, Ni, Cu, Co, Mn or Cd or a mixture of two or more of these, or when z is 1, M is Li. Suitably, z is 2 and M is Ca, Mg, Zn or Fe. More suitably, z is 2 and M is Ca, Mg or Zn.

In an embodiment, in step a), a layered double hydroxide of formula (IA) or formula (IB) is provided wherein when y is 3, M′ is Al, Ga, Y, In, Fe, Co, Ni, Mn, Cr, Ti, V, La or a mixture thereof, or when y is 4, M′ is Sn, Ti or Zr or a mixture thereof. Suitably, y is 3. More suitably, y is 3 and M′ is Al. Suitably, M′ is Al.

In an embodiment, in step a), a layered double hydroxide of formula (IA) or formula (IB) is provided wherein x has a value according to the expression 0.18<x<0.9. Suitably, x has a value according to the expression 0.18<x<0.5. More suitably, x has a value according to the expression 0.18<x<0.4.

In an embodiment, in step a), a layered double hydroxide of formula (IA) or formula (IB) is provided which is a Zn/Al, Mg/Al, ZnMg/Al, Ni/Ti, Mg/Fe, Ca/Al, Ni/AI or Cu/AI layered double hydroxide.

The anion(s) X in the LDH may be any appropriate organic or inorganic anion, for example halide (e.g., chloride), inorganic oxyanions (e.g. X′ₘOₙ(OH)ₚ^{q-}; m=1-5; n=2-10; p=0-4, q=1-5; X′=B, C, N, S, P: e.g. carbonate, bicarbonate, hydrogenphosphate, dihydrogenphosphate, nitrite, borate, nitrate, phosphate, sulphate), anionic surfactants (such as sodium dodecyl sulfate, fatty acid salts or sodium stearate), anionic chromophores, and/or anionic UV absorbers, for example 4-hydroxy-3-methoxybenzoic acid, 2-hydroxy-4-methoxybenzophenone-5-sulfonic acid (HMBA), 4-hydroxy-3-methoxy-cinnamic acid, p-aminobenzoic acid and/or urocanic acid. In an embodiment, the anion X is an inorganic oxyanion selected from carbonate, bicarbonate, hydrogenphosphate, dihydrogenphosphate, nitrite, borate, nitrate, sulphate or phosphate or a mixture of two or more thereof. More suitably, the anion X is an inorganic oxyanion selected from carbonate, bicarbonate, phosphate, borate, nitrate or nitrite. More suitably, the anion X is an inorganic oxyanion selected from carbonate, bicarbonate, nitrate or nitrite. Most suitably, the anion X is carbonate.

In a particularly suitable embodiment, in step a), a layered double hydroxide of formula (IA) or formula (IB) is provided wherein, M is Ca, Mg, Zn and/or Fe, M′ is Al, and X is carbonate, bicarbonate, phosphate, borate, nitrate or nitrite. Suitably, M is Ca, Mg and/or Zn, M′ is Al, and X is carbonate, bicarbonate, phosphate, borate, nitrate or nitrite. More suitably, M is Ca, Mg and/or Zn, M′ is Al, and X is carbonate, nitrate, phosphate or borate.

In a particularly suitable embodiment, in step a), a layered double hydroxide of formula (IA) or formula (IB) is provided wherein, M is Ca, Mg, Zn or Fe, M′ is Al, and X is carbonate, bicarbonate, nitrate or nitrite. Suitably, M is Ca, Mg or Zn, M′ is Al, and X is carbonate, bicarbonate, nitrate or nitrite. More suitably, M is Ca, Mg or Zn, M′ is Al, and X is carbonate.

In an embodiment, in step a), a layered double hydroxide of formula (IA) or formula (IB) is provided wherein M is Mg, M′ is Al and X is carbonate, nitrate, phosphate or borate.

In an embodiment, in step a), a layered double hydroxide of formula (IA) or formula (IB) is provided wherein M is Zn and Mg, M′ is Al, X is carbonate, nitrate, phosphate or borate.

In an embodiment, in step a), a layered double hydroxide of formula (IA) or formula (IB) is provided wherein M is Mg, M′ is Al and X is carbonate.

In an embodiment, in step a), a layered double hydroxide of formula (IA) or formula (IB) is provided wherein M is Zn and Mg, M′ is Al, X is carbonate.

In an embodiment, in step a), a layered double hydroxide of formula (IA) or formula (IB) is provided with the formula Mg_{q}Al—X, wherein X is carbonate, nitrate, phosphate or borate, and 1.8≤q≤5, preferably wherein 1.8≤q≤3.5.

In an embodiment, in step a), a layered double hydroxide of formula (IA) or formula (IB) is provided with the formula ZnₚMg_{q}Al—X, wherein X is carbonate, nitrate, phosphate or borate, and 0.5≤p≤2.5 and 0.5≤q≤2.5.

In an embodiment, in step a), a layered double hydroxide of formula (IA) or formula (IB) is provided with the formula Mg_{q}Al—CO₃, wherein 1.8≤q≤5, and preferably wherein 1.8≤q≤3.5.

In an embodiment, in step a), a layered double hydroxide of formula (IA) or formula (IB) is provided with the formula ZnₚMg_{q}Al—CO₃, wherein 0.5≤p≤2.5 and 0.5≤q≤2.5.

In an embodiment, in step a), a layered double hydroxide of formula (IA) or formula (IB) is provided which is a Zn₂MgAl—CO₃ layered double hydroxide.

In an embodiment, in step a), a layered double hydroxide of formula (IA) or formula (IB) is provided which is a Mg₃Al—CO₃ layered double hydroxide.

In an embodiment, in step a), a layered double hydroxide of formula (IA) or formula (IB) is provided which is a Mg₂Al—CO₃ layered double hydroxide.

In an embodiment, in step a), a layered double hydroxide of formula (IA) or formula (IB) is provided which is a Zn₂Al—NO₃ layered double hydroxide.

In an embodiment, in step a), a layered double hydroxide of formula (IA) or formula (IB) is provided which is a Zn₂Al—PO₄ layered double hydroxide.

In an embodiment, in step a), a layered double hydroxide of formula (IA) or formula (IB) is provided which is a Zn₂Al—BO₃ layered double hydroxide.

The organic solvent, L, present in formula (IB) may have any suitable hydrogen bond donor and/or acceptor groups, so that it is capable of hydrogen-bonding to water. Hydrogen bond donor groups include R—OH, R—NH₂, R₂NH, whereas hydrogen bond acceptor groups include ROR, R₂C═O, RNO₂, R₂NO, R₃N, ROH, RCF₃. The term ‘AMO’ refers to aqueous-miscible organic solvents, such as ethanol, methanol and acetone. In the context of this application ‘AMO’ is used to refer to solvents which are capable of hydrogen-bonding to water and as such, other organic solvents with limited aqueous miscibility (such as ethyl acetate) are also envisaged within the scope of an ‘AMO’, for example when used in the term ‘AMO-LDH’.

In an embodiment, L is selected from acetone, acetonitrile, dimethylformamide, dimethyl sulphoxide, dioxane, ethanol, methanol, n-propanol, isopropanol, tetrahydrofuran, ethyl acetate, n-butanol, sec-butanol, n-pentanol, n-hexanol, cyclohexanol, diethyl ether, diisopropyl ether, di-n-butyl ether, methyl tert-butyl ether (MTBE), tert-amyl methyl ether, cyclopentyl methyl ether, cyclohexanone, methyl ethyl ketone (MEK), methyl isobutyl ketone (MIBK), methyl isoamyl ketone, methyl n-amyl ketone, furfural, methyl formate, methyl acetate, isopropyl acetate, n-propyl acetate, isobutyl acetate, n-butyl acetate, n-amyl acetate, n-hexyl acetate, methyl amyl acetate, methoxypropyl acetate, 2-ethoxyethyl acetate, nitromethane, and a mixture of two or more thereof.

Suitably, L is selected from acetone, ethanol, ethyl acetate, and a mixture of two or more thereof. In one embodiment L is ethanol.

In an embodiment, in step a), a layered double hydroxide of formula (IB) is provided wherein M is Mg, M′ is Al, X is carbonate, nitrate, phosphate or borate and L is ethanol or acetone.

In an embodiment, in step a), a layered double hydroxide of formula (IB) is provided wherein M is Zn and Mg, M′ is Al, X is carbonate, nitrate, phosphate or borate and L is ethanol.

In an embodiment, in step a), a layered double hydroxide of formula (IB) is provided wherein M is Zn and Mg, M′ is Al, X is carbonate, nitrate, phosphate or borate and L is ethanol or acetone.

In an embodiment, in step a), a layered double hydroxide of formula (IB) is provided which is a Zn₂MgAl—X layered double hydroxide, wherein X is carbonate, nitrate, phosphate or borate, and wherein L is ethanol.

In an embodiment, in step a), a layered double hydroxide of formula (IB) is provided wherein M is Mg, M′ is Al, X is carbonate and L is ethanol or acetone.

In an embodiment, in step a), a layered double hydroxide of formula (IB) is provided wherein M is Zn and Mg, M′ is Al, X is carbonate and L is ethanol.

In an embodiment, in step a), a layered double hydroxide of formula (IB) is provided wherein M is Zn and Mg, M′ is Al, X is carbonate and L is ethanol or acetone.

In an embodiment, in step a), a layered double hydroxide of formula (IB) is provided which is a Zn₂MgAl—CO₃ layered double hydroxide and L is ethanol.

In an embodiment, b has a value according to the expression 0<b≤7.5. Suitably, b has a value according to the expression 0<b≤5. More suitably, b has a value according to the expression 0<b≤3. Even more suitably, b has a value according to the expression 0<b≤1 (e.g. 0.2<b≤0.95).

In an embodiment, c has a value according to the expression 0<c≤7.5. Suitably, c has a value according to the expression 0<c≤5. More suitably, c has a value according to the expression 0<c≤1. Most suitably, c has a value according to the expression 0<c≤0.5.

In an embodiment, the layered double hydroxide of formula (IA) is prepared by a process comprising the step of
I. providing a water-washed, wet precipitate of formula (IA), said precipitate having been formed by contacting aqueous solutions containing cations of the metals M and M′, the anion(s) Xⁿ⁻, and optionally an ammonia-releasing agent, and then ageing the reaction mixture;
II. isolating and drying the wet precipitate; and optionally
III. grinding the dried precipitate to a powder form.

The wet precipitate may be isolated in step II) by means of filtration (e.g. vacuum filtration), centrifugation, or other separation means as will be apparent to one skilled in the art.

The drying of the precipitated LDH may be carried out by various means such as heating, drying under vacuum or a combination of both, for example at 50-150° C. under vacuum. In an embodiment the drying step comprises drying under vacuum at 100-120° C.

Step III) involves reducing the particle size and/or increasing the surface area of the dried LDH by a grinding step. Other suitable methods for carrying out this step will be apparent to the skilled person, such as ball milling, jet milling or centrifugal grinding.

In an embodiment, the layered double hydroxide of formula (IB) is prepared by a process comprising the steps of
I. providing a water-washed, wet precipitate of formula (IA) said precipitate having been formed by contacting aqueous solutions containing cations of the metals M and M′, the anion(s) Xⁿ⁻, and optionally an ammonia-releasing agent, and then ageing the reaction mixture;
IIA. contacting the water-washed, wet precipitate of step I) with a solvent L, as defined for formula (IB).

When a layered double hydroxide of formula (IB) is prepared, the water-washed wet precipitate is not allowed to dry prior to it being contacted with the solvent according to step (IIA). The wet precipitate may have a moisture content of 15 to 60% relative to the total weight of the wet precipitate.

It will be understood that the water-washed wet precipitate of step (I) may be pre-formed. Alternatively, the water-washed wet precipitate of step I) may be prepared as part of step (I), in which case step (I) comprises the following steps:
(i) precipitating a layered double hydroxide having the formula (IA) from an aqueous solution containing cations of the metals M and M′, the anion(s) Xⁿ⁻, and optionally an ammonia-releasing agent;
(ii) ageing the layered double hydroxide precipitate obtained in step (i) in the reaction mixture of step (i);
(iii) collecting the aged precipitate resulting from step (ii), then washing it with water and optionally a solvent; and
(iv) drying and/or filtering the washed precipitate to the point that it is still damp.

The ammonia-releasing agent used in step (i) may increase the aspect ratio of the resulting LDH platelets. Suitable ammonia-releasing agents include hexamethylene tetraamine (HMT) and urea. Suitably, the ammonia-releasing agent is urea. The amount of ammonia-releasing agent used in step i) may be such that the molar ratio of ammonia-releasing agent to metal cations (M+M′) is 0.5:1 to 10:1 (e.g. 1:1 to 6:1 or 4:1 to 6:1).

In an embodiment, in step (i), the precipitate is formed by contacting aqueous solutions containing cations of the metals M and M′, the anion Xⁿ⁻, and optionally an ammonia-releasing agent, in the presence of a base being a source of OH⁻ (e.g. NaOH, NH₄OH, or a precursor for OH⁻ formation). Suitably the base is NaOH. In an embodiment, the quantity of base used is sufficient to control the pH of the solution above 6.5. Suitably, the quantity of base used is sufficient to control the pH of the solution at 6.5-13. More suitably, the quantity of base used is sufficient to control the pH of the solution at 7.5-13. Yet more suitably, the quantity of base used is sufficient to control the pH of the solution at 9-11.

In an embodiment, in step (ii), the layered double hydroxide precipitate obtained in step i) is aged in the reaction mixture of step (i) for a period of 5 minutes to 72 hours at a temperature of 15-180° C. In an embodiment, in step (ii), the layered double hydroxide precipitate obtained in step i) is aged in the reaction mixture of step (i) for a period of 3 to 15 hours at a temperature of 100-160° C.; preferably for 3 to 5 hours at a temperature of 130-160° C.; most preferably for 5 hours at a temperature of 150° C.

Suitably, in step (ii), the layered double hydroxide precipitate obtained in step (i) is aged in the reaction mixture of step (i) for a period of 1 to 72 hours. More suitably, in step (ii), the layered double hydroxide precipitate obtained in step (i) is aged in the reaction mixture of step (i) for a period of 2 to 12 hours. Most suitably, in step (ii), the layered double hydroxide precipitate obtained in step (i) is aged in the reaction mixture of step (i) for a period of 2 to 6 hours.

Suitably, in step (ii), the layered double hydroxide precipitate obtained in step (i) is aged in the reaction mixture of step (i) at a temperature of 15-180° C. More suitably, in step (ii), the layered double hydroxide precipitate obtained in step (i) is aged in the reaction mixture of step (i) at a temperature 100-160° C.; preferably at 130-160° C.; most preferably at 150° C.

Step (ii) may be performed in an autoclave.

In an embodiment, in step (iii), the aged precipitate resulting from step (ii) is collected, then washed with water until the filtrate has a pH in the range of 6.5-7.5. Suitably, step (iii) comprises washing the aged precipitate resulting from step (ii) with water at a temperature of 15-100° C. (e.g. 18-40° C.). Optionally the precipitate may be washed with a mixture of water and solvent. Suitably, the solvent is selected from ethyl acetate, ethanol and acetone. More suitably, the quantity of solvent in the washing mixture is 5-95% (v/v), preferably 30-70% (v/v).

In an embodiment, in step IIA) the water-washed wet precipitate is contacted with a solvent L by dispersing said precipitate in the solvent L to produce a slurry. In a further embodiment, the preparation process comprises a further step IIIA) of maintaining the slurry resulting from step IIA). In an embodiment, the slurry produced in step IIA) and then maintained in step IIIA) contains 1-100 g of water-washed wet precipitate per 1 litre of solvent L. Suitably, the slurry produced in step IIA) and maintained in step IIIA) contains 1-75 g of water-washed wet precipitate per 1 litre of solvent L. More suitably, the slurry produced in step IIA) and maintained in step IIIA) contains 1-50 g of water-washed wet precipitate per 1 litre of solvent L. Most suitably, the slurry produced in step IIA) and maintained in step IIIA) contains 1-30 g of water-washed wet precipitate per 1 litre of solvent L.

In step IIIA), the slurry produced in step IIA) is maintained for a period of time. Suitably, the slurry is stirred during step IIIA).

In an embodiment, in step IIIA), the slurry is maintained for a period of 0.5 to 120 hours (e.g. 0.5 to 96 hours). Suitably, in step IIIA), the slurry is maintained for a period of 0.5 to 72 hours. More suitably, in step IIIA), the slurry is maintained for a period of 0.5 to 48 hours. Even more suitably, in step IIIA), the slurry is maintained for a period of 0.5 to 24 hours. Yet more suitably, in step IIIA), the slurry is maintained for a period of 0.5 to 24 hours. Most suitably, in step IIIA), the slurry is maintained for a period of 1 to 2 hours. Alternatively, in step IIIA), the slurry is maintained for a period of 16 to 20 hours.

The LDH resulting from step IIIA) may be isolated by any suitable means, including filtering, filter pressing, spray drying, cycloning and centrifuging. The isolated AMO-LDH may then be dried to give a free-flowing powder. The drying may be performed under ambient conditions, in a vacuum, or by heating to a temperature below 60° C. (e.g. 20 to 60° C.). Suitably, the AMO-LDH resulting from step IIIA) is isolated and then heated to a temperature of 10-40° C. in a vacuum until a constant mass is reached. In an embodiment, the AMO-LDH may be dried by heating at 50° C.-200° C., such as 100° C.-200° C., for example 150° C.-200° C.

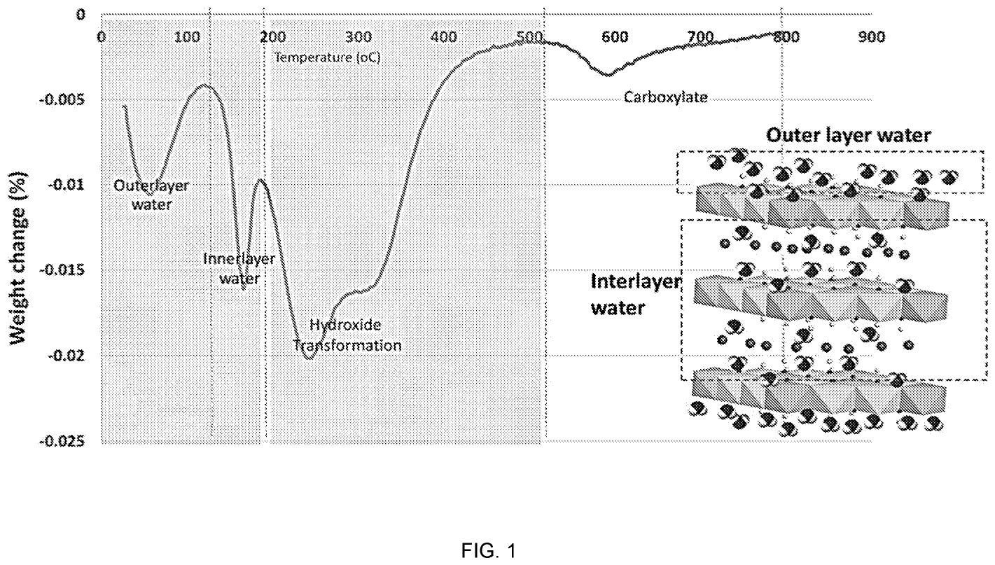

Step b) of the process for forming a modified LDH comprises heating the layered double hydroxide to 110-200° C. Layered double hydroxides (whether treated with an AMO solvent or untreated) have a propensity to absorb atmospheric moisture. Such materials can become difficult to modify and process and can exhibit reduced shelf-lives. To overcome these problems, it has been surprisingly found that the surface modification of step c) benefits from a preceding thermal treatment of the LDH being carried out. FIG. 1 shows a DTA (Differential Thermal Analysis) scan for a Zn₂MgAl—CO₃ LDH sample. It highlights the presence of two differently bound water species in an LDH; weakly-bound ‘outer layer’ water is lost by heating the LDH to 100° C., whereas the strongly-bound ‘interlayer’ water is lost at higher temperatures of between 100° C. and 200° C. In some circumstances, at high temperatures (e.g. above 200° C. or 250° C.) the layered double hydroxide may be in the form of a layered double oxide, or a mixture of layered double hydroxide and layered double oxide. In order to remove deleterious outer layer and interlayer water, it is important to heat the layered double hydroxide at 110-200° C., prior to mixing it with a modifier. In an embodiment, in step b) the layered double hydroxide is heated to 130-200° C. In an embodiment, in step b) the layered double hydroxide is heated to 130-180° C. In an embodiment, in step b) the layered double hydroxide is heated to 130-160° C. In an embodiment, in step b) the layered double hydroxide is heated to 150° C. In an embodiment, in step b) the layered double hydroxide is heated for 1-24 hours. In an embodiment, in step b) the layered double hydroxide is heated for 2-6 hours. In an embodiment, in step b) the layered double hydroxide is heated for 4 hours. In an embodiment, in step b) the layered double hydroxide is heated to 110-200° C. for 1-24 hours. In an embodiment, in step b) the layered double hydroxide is heated to 130-160° C. for 2-6 hours. In an embodiment, in step b) the layered double hydroxide is heated to 150° C. for 4 hours.

It has been discovered to be advantageous to carry out a surface modification of the heat-treated layered double hydroxide (step c) by mixing it with modifier in the presence of less than or equal to 50% by weight of a solvent, relative to the total weight of the layered double hydroxide and the modifier. For the avoidance of doubt, and purely as an example, if 1 g of heat-treated LDH is mixed with 0.5 g of modifier, then 50% by weight of a solvent would be 0.75 g of solvent. In an embodiment, in step c) the mixing is conducted in the presence of less than or equal to 10% by weight of a solvent, relative to the total weight of the layered double hydroxide and the modifier. In an embodiment, the mixing in step c) is conducted with substantially no, or no solvent present.

Preferably, the mixing in step c) is carried out straight after the heat treatment of step b). In an embodiment, in between the thermal treatment of the layered double hydroxide in step b) and the mixing with modifier in step c), the layered double hydroxide is not allowed to cool down to ambient temperature. In an embodiment, in between the thermal treatment of the layered double hydroxide in step b) and the mixing with modifier in step c), the layered double hydroxide is not allowed to cool down to below 50° C., preferably to not below 80° C., most preferably to not below 110° C.

In an embodiment, step b) and step c) are carried out substantially simultaneously.

Preferably, the surface modification of step c) is carried out at elevated temperature. In an embodiment, in step c) the mixing takes place at 60-270° C. In an embodiment, in step c) the mixing takes place at 70-200° C. In an embodiment, in step c) the mixing takes place at 110-200° C. In an embodiment, in step c) the mixing takes place at 130-180° C. In an embodiment, in step c) the mixing takes place at 130-160° C. In an embodiment, in step c) the mixing takes place at 150° C.

In another embodiment, in step c) the mixing takes place at 60-200° C. Suitably, in step c) the mixing takes place at 60-180° C. More suitably, in step c) the mixing takes place at 60-160° C.

In an embodiment, in step c) the mixing takes place at a temperature above the melting point of the modifier. In an embodiment, in step c) the mixing takes place at a temperature above the melting point of the modifier, wherein the modifier is a salt of stearic acid. In an embodiment, in step c) the mixing takes place at a temperature 20-30° C. above the melting point of the modifier, preferably wherein the modifier is a salt of stearic acid, such as zinc stearate.

In an embodiment, in step c) the mixing is maintained for a period of 15 minutes-2 hours and suitably 30 minutes to 1 hour.

Step c) may be conducted in dry air (such as not more than 20% RH) or under an inert atmosphere (e.g. under a N2 blanket). In an embodiment, step c) is conducted under an inert atmosphere.

In an embodiment, the quantity of the modifier used in step c) is 1-25% by weight relative to the weight of the layered double hydroxide. In an embodiment, the quantity of the modifier used in step c) is 1-15% by weight relative to the weight of the layered double hydroxide. In an embodiment, the quantity of the modifier used in step c) is 3-15% by weight relative to the weight of the layered double hydroxide. In an embodiment, the quantity of the modifier used in step c) is 1-7% by weight relative to the weight of the layered double hydroxide. In an embodiment, the mixing in step c) is conducted using more than 5% by weight modifier, relative to the weight of layered double hydroxide. In an embodiment, the mixing in step c) is conducted using more than 10% by weight modifier, relative to the weight of layered double hydroxide. In an embodiment, the mixing in step c) is conducted using about 15% by weight modifier, relative to the weight of layered double hydroxide. In an embodiment, the mixing in step c) is conducted using 10-20% by weight modifier, relative to the weight of layered double hydroxide, when the layered double hydroxide has a surface area of 70-125 m²/g, preferably 15% wt modifier when the layered double hydroxide has a surface area of 80-100 m²/g. In an embodiment, the mixing in step c) is conducted using 1-10% by weight modifier, relative to the weight of layered double hydroxide, when the layered double hydroxide has a surface area of 10-70 m²/g, preferably 7% wt modifier when the layered double hydroxide has a surface area of 30-50 m²/g.

In a preferred embodiment, the modifier in step c) is selected from the group consisting of fatty acids, fatty acid salts, sulfate modifiers, phosphonate modifiers, phthalate modifiers and organosilane modifiers.

Fatty acids are typically long-chain carboxylic acids and may comprise one or more C═C double bonds. Examples of fatty acids include caproic acid, lauric acid, myristic acid, palmitic acid, stearic acid, maleic acid, erucic acid, oleic acid, arachidic acid and linoleic acid. Fatty acid salts are typical salts of the above-mentioned fatty acids. Metal salts of fatty acids include sodium salts, lithium salts, magnesium salts, calcium salts and zinc salts, such as zinc salts.

Sulfate modifiers are metal salts of long-chain (e.g. up to 20 carbon atoms) sulfuric acids, such as sodium dodecyl sulfate. Owing to its low flash point, sodium dodecyl sulfate may require the use of an inert atmosphere.

Phosphonate modifiers are metal salts of long-chain (e.g. up to 20 carbon atoms) phosphonic acids, such as sodium octadecyl phosphonate.

Phthalate modifiers are dialkyl esters of phthalic acid, such as dioctyl terephthalate (DOTP), diisodecyl phthalate (DIDP), diisononyl phthalate (DINP), dioctyl phthalate (DOP) and dibutyl phthalate (DBP).

Organosilane modifiers may be a hydroxysilane, alkoxysilane, or siloxane compound. Siloxane modifiers include polysiloxanes such as polydimethylsiloxane. The term “alkoxy” as used herein refers to an —O-alkyl group (wherein alkyl is straight or branched chain and comprises 1 to 6 carbon atoms) such as methoxy, ethoxy, propoxy, isopropoxy, butoxy, tert-butoxy, pentoxy, and hexoxy.

In an embodiment, the organosilane modifier is an alkoxysilane compound.

In an embodiment, the organosilane modifier is selected from the group consisting of 3-aminopropyltriethoxysilane, (3-glycidyloxypropyl)triethoxysilane, (3-glycidyloxypropyl)-trimethoxysilane, (3-mercaptopropyl)-triethoxysilane, triethoxyvinylsilane, triethoxyphenylsilane, trimethoxy(octadecyl)silane, vinyl-tris(2-methoxy-ethoxy)silane, g-methacryloxy-propyltrimethoxysilane, g-aminopropyl-trimethoxysilane, b(3,4-epxycryclohexyl)-ethyltrimethoxysilane, g-mercaptopropyltrimethoxysilane, (3-aminopropyl)triethoxysilane, N-(3-triethoxysilylpropyl)ethylenediamine, 3-aminopropyl-methyl-diethoxysilane, vinyltrimethoxy-silane, chlorotrimethylsilane, tert-butyldimethylsilyl chloride, trichlorovinylsilane, methyltrichlorosilane, 3-chloropropyl trimethoxysilane, chloromethyltrimethylsilane, diethoxy-dimethylsilane, trimethoxypropylsilane, trimethoxyoctylsilane, triethoxyoctylsilane, trichloro(octadecyl)silane and γ-piperazinylpropylmethyldimethoxysilane.

Suitably, the organosilane modifier is selected from the group consisting of trimethoxypropylsilane, trimethoxyoctylsilane, (3-glycidyloxypropyl)-trimethoxysilane and (3-aminopropyl)triethoxysilane.

In an embodiment, the modifier is selected from the group consisting of:
stearic acid, lauric acid, palmitic acid, arachidic acid, maleic acid and oleic acid;
metal salts of stearic acid, lauric acid, palmitic acid, arachidic acid, maleic acid and oleic acid;
sodium dodecyl sulfate;
sodium octadecyl phosphonate;
dioctyl terephthalate, diisodecyl phthalate, diisononyl phthalate, dioctyl phthalate and dibutyl phthalate; and
trimethoxypropylsilane, trimethoxyoctylsilane, (3-glycidyloxypropyl)-trimethoxysilane and (3-aminopropyl)triethoxysilane.

In an embodiment, the modifier is selected from the group consisting of:
stearic acid, lauric acid, palmitic acid, arachidic acid, maleic acid and oleic acid;
metal salts of stearic acid, lauric acid, palmitic acid, arachidic acid, maleic acid and oleic acid;
sodium octadecyl phosphonate;
dioctyl terephthalate, diisodecyl phthalate, diisononyl phthalate, dioctyl phthalate and dibutyl phthalate; and
trimethoxypropylsilane, trimethoxyoctylsilane, (3-glycidyloxypropyl)-trimethoxysilane and (3-aminopropyl)triethoxysilane.

In an embodiment, the modifier is selected from the group consisting of:
stearic acid, lauric acid, palmitic acid, arachidic acid, maleic acid and oleic acid;
metal salts of stearic acid, lauric acid, palmitic acid, arachidic acid, maleic acid and oleic acid;
dioctyl terephthalate, diisodecyl phthalate, diisononyl phthalate, dioctyl phthalate and dibutyl phthalate; and
trimethoxypropylsilane, trimethoxyoctylsilane, (3-glycidyloxypropyl)-trimethoxysilane and (3-aminopropyl)triethoxysilane.

In an embodiment, the modifier is selected from the group consisting of:
stearic acid and lauric acid;
metal salts of stearic acid and lauric acid;
dioctyl terephthalate, diisodecyl phthalate, diisononyl phthalate, dioctyl phthalate and dibutyl phthalate; and
trimethoxypropylsilane, trimethoxyoctylsilane, (3-glycidyloxypropyl)-trimethoxysilane and (3-aminopropyl)triethoxysilane.

In an embodiment, the modifier is lithium stearate, zinc stearate, magnesium stearate, calcium stearate or sodium stearate.

In an embodiment, the modifier is zinc stearate. In an embodiment, the mixing in step c) is conducted using 12-17% by weight of zinc stearate, relative to the weight of layered double hydroxide. In an embodiment, the modifier is zinc stearate. In an embodiment, the mixing in step c) is conducted using 13-16% by weight of zinc stearate, relative to the weight of layered double hydroxide. In an embodiment, the modifier is zinc stearate. In an embodiment, the mixing in step c) is conducted using 15% by weight of zinc stearate, relative to the weight of layered double hydroxide.

In an embodiment, the modifier is a fatty acid (such as maleic acid) and the mixing in step c) is carried out at 130-200° C., preferably at 150-180° C., more preferably at 170° C.

In an embodiment, the modifier is a fatty acid salt (such as zinc stearate) and the mixing in step c) is carried out at 110-200° C., preferably at 130-180° C., more preferably at 130-160° C., most preferably at 150° C.

In an embodiment, the modifier is zinc stearate and the mixing in step c) is carried out at 130-160° C. In an embodiment, the modifier is zinc stearate and the mixing in step c) is carried out at 150° C. In a preferred embodiment, the modifier is zinc stearate and the mixing in step c) is carried out at 130-160° C. for 15 minutes to 2 hours, such as for 30 minutes.

In an embodiment, the modifier is a sulfate (such as sodium dodecyl sulfate) and the mixing in step c) is carried out at 190-270° C., preferably at 210-250° C., more preferably at 230° C.

In an embodiment, the modifier is a phosphonate (such as sodium octadecyl phosphonate) and the mixing in step c) is carried out at 160-240° C., preferably at 180-220° C., more preferably at 200° C.

In an embodiment, the modifier is an organosilane (such as (3-glycidyloxypropyl)-trimethoxysilane) and the mixing in step c) is carried out at 60-140° C., preferably at 80-130° C., more preferably at 120° C.

In an embodiment the modifier is chosen from dioctyl terephthalate, diisodecyl phthalate, diisononyl phthalate, dioctyl phthalate and dibutyl phthalate.

In an embodiment, the modifier is chosen from dioctyl terephthalate, diisodecyl phthalate, diisononyl phthalate, dioctyl phthalate and dibutyl phthalate and the mixing in step c) is carried out at 70-120° C., preferably at 100° C.

The mixing in step c) can be carried out by a variety of means which can provide simultaneous heating and mechanical mixing to a batch of material to be mixed. Suitable means comprise a vortex mixer, fluidised bed mixer, internal mixer, Labo mixer or high-speed mixer. In an embodiment, the mixing in step c) is carried out by means of vapour treatment, a dry mixer, a vortex mixer, or by milling the layered double hydroxide in the presence of the modifier. In an embodiment, the mixing in step c) is carried out by means of a high-speed mixer.

### Modified LDHs of the Invention

In another aspect, the present invention provides a modified layered double hydroxide obtainable, obtained or directly obtained by a process defined herein.

In an embodiment, a modified layered double hydroxide obtained by a process according to the present invention has a BET surface area (as determined by N2 adsorption) of at least 20 m²/g. Suitably, the modified layered double hydroxide has a BET surface area of at least 32 m²/g. More suitably, the modified layered double hydroxide has a BET surface area of at least 40 m²/g. Even more suitably, the modified layered double hydroxide has a BET surface area of at least 50 m²/g. In an embodiment, a modified layered double hydroxide obtained by a process according to the present invention has a BET surface area of 10-55 m²/g, such as 10-30 m²/g.

In an embodiment, a modified layered double hydroxide obtained by a process according to the present invention has a loose bulk density of greater than 0.3 g/mL. In an embodiment, the modified layered double hydroxide has a loose bulk density of greater than 0.4 g/mL. In an embodiment, the modified layered double hydroxide has a loose bulk density of greater than 0.5 g/mL. In an embodiment, the modified layered double hydroxide has a loose bulk density of greater than 0.6 g/mL. In an embodiment, the modified layered double hydroxide has a tapped density of greater than 0.5 g/mL. In an embodiment, the modified layered double hydroxide has a tapped density of greater than 0.6 g/mL In an embodiment, the modified layered double hydroxide has a tapped density of greater than 0.7 g/mL. In an embodiment, the modified layered double hydroxide has a tapped density of greater than 0.8 g/mL.

In an embodiment, a modified layered double hydroxide obtained by a process according to the present invention has a moisture uptake level of less than 6 wt % of dry LDH, when measured at RH60 at 25° C. for 3 hours. Suitably, the modified layered double hydroxide has a moisture uptake level of less than 4 wt % of dry LDH, when measured at RH60 at 25° C. for 3 hours. More suitably, the modified layered double hydroxide has a moisture uptake level of less than 2 wt % of dry LDH, when measured at RH60 at 25° C. for 3 hours. Most suitably, the modified layered double hydroxide has a moisture uptake level of less than 1 wt % of dry LDH, when measured at RH60 at 25° C. for 3 hours.

In an embodiment, a modified layered double hydroxide obtained by a process according to the present invention has a contact angle greater than or equal to 100°. Suitably, the modified layered double hydroxide has a contact angle greater than or equal to 110°. More suitably, the modified layered double hydroxide has a contact angle greater than or equal to 120°.

In an embodiment, a modified layered double hydroxide obtained by a process according to the present invention has greater dispersion in an oil phase (such as 1-hexene), than in an aqueous phase, when the modified layered double hydroxide is allowed to partition between a mixture of the two phases.

In an embodiment, a modified layered double hydroxide obtained by a process according to the present invention has a contact angle greater than or equal to 100° and a moisture uptake level of less than 6 wt % of dry LDH, when measured at RH60 at 25° C. for 3 hours. In an embodiment, a modified layered double hydroxide obtained by a process according to the present invention has a contact angle greater than or equal to 110° and a moisture uptake level of less than 4 wt % of dry LDH, when measured at RH60 at 25° C. for 3 hours. In an embodiment, a modified layered double hydroxide obtained by a process according to the present invention has a contact angle greater than or equal to 120° and a moisture uptake level of less than 2 wt % of dry LDH, when measured at RH60 at 25° C. for 3 hours.

### Applications of the LDHs

As described hereinbefore, the present invention also provides a composite material comprising a modified layered double hydroxide as defined herein dispersed throughout a polymer.

LDHs have a variety of interesting properties that make them attractive materials for use as fillers in polymeric composites. However, given that conventionally-prepared LDHs are only dispersible in aqueous solvents, the preparation of polymer-LDH composite materials using polymers that are soluble in organic solvents has been restricted.

Owing to their increased hydrophobicity and reduced water content, the modified LDHs of the invention have improved processability with polymers to produce composite materials. This allows the preparation of a homogenous mixture of modified LDH and polymer, which can be processed into a LDH-polymer composite material, wherein the modified LDH is uniformly dispersed throughout the polymeric matrix.

In an embodiment, the polymer is selected from polypropylene, polyethylene, polyvinyl chloride, polyvinylidene chloride, polylactic acid, polyvinyl acetate, ethylene vinyl alcohol, ethylene vinyl acetate, acrylonitrile butadiene styrene, polymethyl methacrylate, polycarbonate, polyamide, an elastomer, or mixtures of two or more of the aforementioned. In an embodiment, the polymer is a biopolymer.

In a preferred embodiment, the polymer is polyvinyl chloride. In an embodiment, there is provided a composite material comprising a Zn₂MgAl—CO₃ layered double hydroxide obtained by a process according to the present invention, dispersed in a polymer. In an embodiment, there is provided a composite material comprising a Zn₂MgAl—CO₃ layered double hydroxide obtained by a process according to the present invention, dispersed in polyvinyl chloride. Polymer composite materials containing a Zn₂MgAl—CO₃ layered double hydroxide have properties that make them useful as flame retardants. Therefore, the present invention also provides the use of a polymer composite material comprising a Zn₂MgAl—CO₃ layered double hydroxide obtained by a process according to the present invention, as a flame retardant. The present invention further provides the use of a polyvinyl chloride composite material comprising a Zn₂MgAl—CO₃ layered double hydroxide obtained by a process according to the present invention, as a flame retardant.

The low moisture content of the modified layered double hydroxides obtained by a process according to the present invention, not only improves the processability of the modified layered double hydroxides in polymeric composite materials, it also results in composite materials with low, or no void formation and improved colour stability.

As a void is a non-uniformity in a composite material, it can affect the mechanical properties and lifespan of the void-containing composite material. Accordingly, in an embodiment, the composite material comprising a modified layered double hydroxide as defined herein dispersed throughout a polymer, has no voids when subjected to SEM cross-sectional imaging.

Polymer-LDH composites may be subject to undesirable discolouration. Higher colour stability of a composite material is signified by high values of whiteness index (WI) and/or low values of yellowness index (YI). Accordingly, in an embodiment, the composite material comprising a modified layered double hydroxide as defined herein dispersed throughout a polymer, has a WI value greater than 10 and/or a YI value less than 25; preferably a WI value greater than 30 and/or a YI value less than 20; more preferably a WI value greater than 40 and/or a YI value less than 15.

The following numbered statements 1-55 are not claims, but instead describe various aspects and embodiments of the invention:
1. A process for forming a modified layered double hydroxide comprising the steps of:
   a) providing a layered double hydroxide;
   b) heating the layered double hydroxide to 110-200° C.; and
   c) mixing the thermally-treated layered double hydroxide of step b) with a modifier, wherein the mixing is conducted in the presence of less than or equal to 50% by weight of a solvent, relative to the total weight of the layered double hydroxide and the modifier.
2. The process according to statement 1, wherein the modifier is selected from the group consisting of fatty acids, fatty acid salts, sulfate modifiers, phosphonate modifiers, phthalate modifiers and organosilane modifiers.
3. The process according to statement 1, wherein the modifier is selected from the group consisting of fatty acids, fatty acid salts, phthalate modifiers and organosilane modifiers
4. The process according to statement 2 or 3, wherein the organosilane modifier is an alkoxysilane.
5. The process according to statement 4, wherein the modifier is selected from the group consisting of:
   stearic acid, lauric acid, palmitic acid, arachidic acid, maleic acid and oleic acid;
   metal salts of stearic acid, lauric acid, palmitic acid, arachidic acid, maleic acid and oleic acid;
   sodium dodecyl sulfate;
   sodium octadecyl phosphonate;
   dioctyl terephthalate, diisodecyl phthalate, diisononyl phthalate, dioctyl phthalate and dibutyl phthalate; and
   trimethoxypropylsilane, trimethoxyoctylsilane, (3-glycidyloxypropyl)-trimethoxysilane and (3-aminopropyl)triethoxysilane.
6. The process according to statement 4, wherein the modifier is selected from the group consisting of:
   stearic acid, lauric acid, palmitic acid, arachidic acid, maleic acid and oleic acid;
   metal salts of stearic acid, lauric acid, palmitic acid, arachidic acid, maleic acid and oleic acid;
   sodium octadecyl phosphonate;
   dioctyl terephthalate, diisodecyl phthalate, diisononyl phthalate, dioctyl phthalate and dibutyl phthalate; and
   trimethoxypropylsilane, trimethoxyoctylsilane, (3-glycidyloxypropyl)-trimethoxysilane and (3-aminopropyl)triethoxysilane.
7. The process according to statement 4, wherein the modifier is selected from the group consisting of:
   stearic acid, lauric acid, palmitic acid, arachidic acid, maleic acid and oleic acid;
   metal salts of stearic acid, lauric acid, palmitic acid, arachidic acid, maleic acid and oleic acid;
   dioctyl terephthalate, diisodecyl phthalate, diisononyl phthalate, dioctyl phthalate and dibutyl phthalate; and
   trimethoxypropylsilane, trimethoxyoctylsilane, (3-glycidyloxypropyl)-trimethoxysilane and (3-aminopropyl)triethoxysilane.
8. The process according to statement 4, wherein the modifier is selected from the group consisting of:
   stearic acid and lauric acid;
   metal salts of stearic acid and lauric;
   dioctyl terephthalate, diisodecyl phthalate, diisononyl phthalate, dioctyl phthalate and dibutyl phthalate; and
   trimethoxypropylsilane, trimethoxyoctylsilane, (3-glycidyloxypropyl)-trimethoxysilane and (3-aminopropyl)triethoxysilane.
9. The process according to any preceding statement, wherein the modifier is lithium stearate, zinc stearate, magnesium stearate, calcium stearate or sodium stearate.
10. The process according to any preceding statement, wherein the modifier is zinc stearate.
11. The process according to any preceding statement, wherein the layered double hydroxide provided in step a) is of formula (IA):

[M^{z+}₁₋ₓM′^{y+}ₓ(OH)₂]^{a+}(Xⁿ⁻)ₘ.bH₂O (IA)
wherein
M is at least one charged metal cation;
M′ is at least one charged metal cation different from M;
z is 1 or 2;
y is 3 or 4;
0<x<0.9;
0<b≤10;
X is at least one anion;
n is the charge on anion(s) X;
a is equal to z(1−x)+xy−2; and
m≥a/n.
12. The process according to any one of statements 1 to 10, wherein the layered double hydroxide provided in step a) is of formula (IB):

[M^{z+}₁₋ₓM′^{y+}ₓ(OH)₂]^{a+}(Xⁿ⁻)ₘ.bH₂O.c(L) (IB)
wherein
M is at least one charged metal cation;
M′ is at least one charged metal cation different from M;
z is 1 or 2;
y is 3 or 4;
0<x<0.9;
0<b≤10;
0<c≤10;
X is at least one anion;
n is the charge on anion(s) X;
a is equal to z(1−x)+xy−2;
m≥a/n; and
L is an organic solvent capable of hydrogen-bonding to water.
13. The process according to statement 11 or 129, wherein when z is 2, M is Mg, Zn, Fe, Ca, Sn, Ni, Cu, Co, Mn or Cd or a mixture of two or more of these, or when z is 1, M is Li.
14. The process according to statement 11, 12 or 13, wherein when y is 3, M′ is Al, Ga, Y, In, Fe, Co, Ni, Mn, Cr, Ti, V, La or a mixture thereof, or when y is 4, M′ is Sn, Ti or Zr or a mixture thereof.
15. The process according to statement 13 or 14, wherein M′ is Al.
16. The process according to any preceding statement, wherein the layered double hydroxide is a Zn/Al, Mg/Al, Mg,Zn/Al, Mg/Al,Sn, Ca/Al, Ni/Ti or Cu/AI layered double hydroxide.
17. The process according to any preceding statement, wherein the layered double hydroxide is a Zn/Al, Mg/AI or Mg,Zn/Al layered double hydroxide.
18. The process according to any one of statements 11 to 17, wherein X is an anion selected from at least one of halide, inorganic oxyanion, or an organic anion (e.g. an anionic surfactant, an anionic chromophore or an anionic UV absorber).
19. The process according to any one of statements 11 to 17, wherein X is an inorganic oxyanion selected from carbonate, bicarbonate, hydrogenphosphate, dihydrogenphosphate, nitrite, borate, nitrate, sulphate or phosphate or a mixture of two or more thereof.
20. The process according to any one of statements 11 to 17, wherein X is an inorganic oxyanion selected from carbonate, nitrate, phosphate or borate, or a mixture of two or more thereof.
21. The process of any one of statements 12 to 20, wherein the layered double hydroxide of formula (IB) is prepared by a process comprising the steps of:
   I. providing a water-washed, wet precipitate of formula (IA), said precipitate having been formed by contacting aqueous solutions containing cations of the metals M and M′, the anion(s) Xⁿ⁻, and optionally an ammonia-releasing agent, and then ageing the reaction mixture;
   IIA. contacting the water-washed, wet precipitate of step I) with a solvent L as defined for formula (IB).
22. The process according to any preceding statement, wherein in step b) the layered double hydroxide is heated to 130-180° C.
23. The process according to statement 22, wherein in step b) the layered double hydroxide is heated to 130-160° C.
24. The process according to any preceding statement, wherein in step c) the mixing is conducted in the presence of less than or equal to 10% by weight of a solvent, relative to the total weight of the layered double hydroxide and the modifier.
25. The process according to any preceding statement, wherein the quantity of the modifier used in step c) is 1-25% by weight relative to the weight of the layered double hydroxide.
26. The process according to statement 25, wherein the quantity of the modifier used in step c) is 1-15% by weight relative to the weight of the layered double hydroxide.
27. The process according to statement 25, wherein the quantity of the modifier used in step c) is 1-7% by weight relative to the weight of the layered double hydroxide.
28. The process according to any preceding statement, wherein in step c) the mixing takes place at 60-270° C.
29. The process according to statement 28, wherein in step c) the mixing takes place at 60-200° C.
30. The process according to statement 28, wherein in step c) the mixing takes place at 60-180° C.
31. The process according to statement 28, wherein in step c) the mixing takes place at 130-180° C.
32. The process according to statement 28, wherein in step c) the mixing takes place at 130-160° C.
33. The process according to statement 28, wherein in step c) the mixing takes place at 60-160° C.
34. The process according to statement 28, wherein in step c) the modifier is a fatty acid (such as maleic acid) and the mixing in step c) is carried out at 130-200° C., preferably at 150-180° C., more preferably at 170° C.
35. The process according to statement 28, wherein in step c) the modifier is a fatty acid salt (such as zinc stearate) and the mixing in step c) is carried out at 110-200° C., preferably at 130-180° C., more preferably at 130-160° C., most preferably at 150° C.
36. The process according to statement 28, wherein in step c) the modifier is a sulfate (such as sodium dodecyl sulfate) and the mixing in step c) is carried out at 190-270° C., preferably at 210-250° C., more preferably at 230° C.
37. The process according to statement 28, wherein in step c) the modifier is a phosphonate (such as sodium octadecyl phosphonate) and the mixing in step c) is carried out at 160-240° C., preferably at 180-220° C., more preferably at 200° C.
38. The process according to statement 28, wherein in step c) the modifier is an organosilane (such as (3-glycidyloxypropyl)-trimethoxysilane) and the mixing in step c) is carried out at 60-140° C., preferably at 80-130° C., more preferably at 120° C.
39. The process according to statement 28, wherein in step c) the modifier is chosen from dioctyl terephthalate, diisodecyl phthalate, diisononyl phthalate, dioctyl phthalate and dibutyl phthalate and the mixing in step c) is carried out at 70-120° C., preferably at 100° C.
40. The process according to statement 1, wherein the mixing in step c) is conducted using 10-20% by weight modifier, relative to the weight of layered double hydroxide, when the layered double hydroxide has a surface area of 70-125 m²/g, preferably 15% wt modifier when the layered double hydroxide has a surface area of 80-100 m²/g.
41. The process according to statement 1, wherein the mixing in step c) is conducted using 1-10% by weight modifier, relative to the weight of layered double hydroxide, when the layered double hydroxide has a surface area of 10-70 m²/g, preferably 7% wt modifier when the layered double hydroxide has a surface area of 30-50 m²/g.
   The process according to statement 1, wherein the layered double hydroxide is a Mg/AI or Mg,Zn/Al layered double hydroxide; in step b) the layered double hydroxide is heated to 130-160° C.; and the modifier is a salt of stearic acid.
42. The process according to statement 1, wherein the layered double hydroxide is a Mg₃Al—CO₃ or Zn₂MgAl—CO₃ layered double hydroxide; in step b) the layered double hydroxide is heated to 130-160° C.; and the modifier is a salt of stearic acid.
43. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is a salt of stearic acid; and in step c) the mixing takes place at a temperature above the melting point of the modifier.
44. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is a salt of stearic acid; and in step c) the mixing takes place at a temperature 20-30° C. above the melting point of the modifier.
45. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is a salt of stearic acid; and in step c) the mixing takes place at 110-200° C.
46. The process according to statement 1, wherein the layered double hydroxide is a Mg/AI or Mg,Zn/Al layered double hydroxide; in step b) the layered double hydroxide is heated to 130-160° C.; and the modifier is zinc stearate.
47. The process according to statement 1, wherein the layered double hydroxide is a Mg₃Al—CO₃ or Zn₂MgAl—CO₃ layered double hydroxide; in step b) the layered double hydroxide is heated to 130-160° C.; and the modifier is zinc stearate.
48. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is zinc stearate; and in step c) the mixing takes place at a temperature above the melting point of the modifier.
49. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is zinc stearate; and in step c) the mixing takes place at a temperature 20-30° C. above the melting point of the modifier.
50. The process according to statement 1, wherein the layered double hydroxide is a Mg₃Al—CO₃ or Zn₂MgAl—CO₃ layered double hydroxide; in step b) the layered double hydroxide is heated to 150° C.; the modifier is zinc stearate; and in step c) the mixing takes place at a temperature above the melting point of the modifier.
51. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is zinc stearate; and in step c) the mixing takes place at 130-160° C.
52. The process according to statement 1, wherein the layered double hydroxide is a Mg₃Al—CO₃ or Zn₂MgAl—CO₃ layered double hydroxide; in step b) the layered double hydroxide is heated to 130-160° C.; the modifier is zinc stearate; and in step c) the mixing takes place at 150° C.
53. The process according to statement 1, wherein the layered double hydroxide is a Mg₃Al—CO₃ or Zn₂MgAl—CO₃ layered double hydroxide; in step b) the layered double hydroxide is heated to 150° C.; the modifier is zinc stearate; and in step c) the mixing takes place at 150° C.
54. A modified layer double hydroxide obtainable by a process according to any one of statements 1 to 53.
55. A composite material comprising a modified layer double hydroxide according to statement 54, dispersed throughout a polymer.

### EXAMPLES

Embodiments of the invention will now be described, for the purpose of illustration only, with reference to the accompanying figures, in which:

FIG. 1 shows the Differential Thermal Analysis scan of Zn₂MgAl—CO₃ LDH between 20° C. and 800° C.

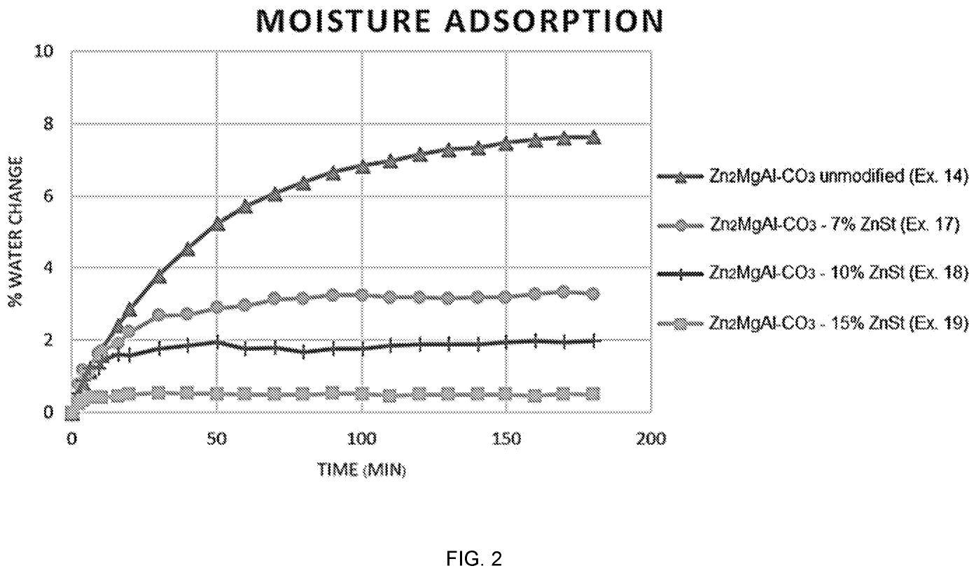

FIG. 2 shows the percentage water uptake of Examples 14, 17, 18 and 19 at various time points after exposure to RH60 at 25° C.

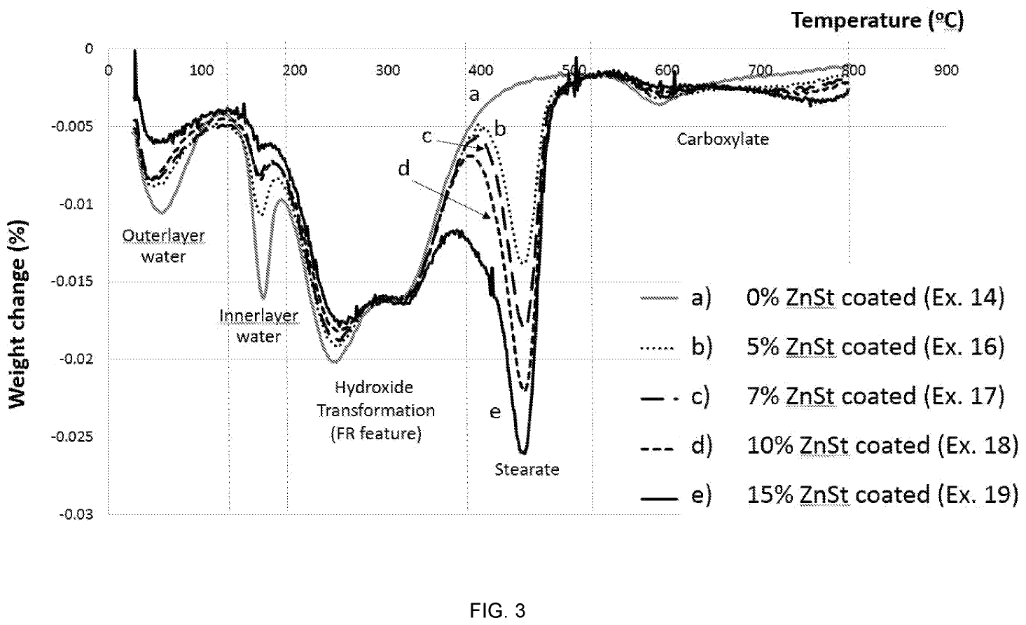

FIG. 3 shows overlaid Differential Thermal Analysis scans of Zn₂MgAl—CO₃ LDH samples (Example 14 and Examples 16-19) between 20° C. and 800° C.

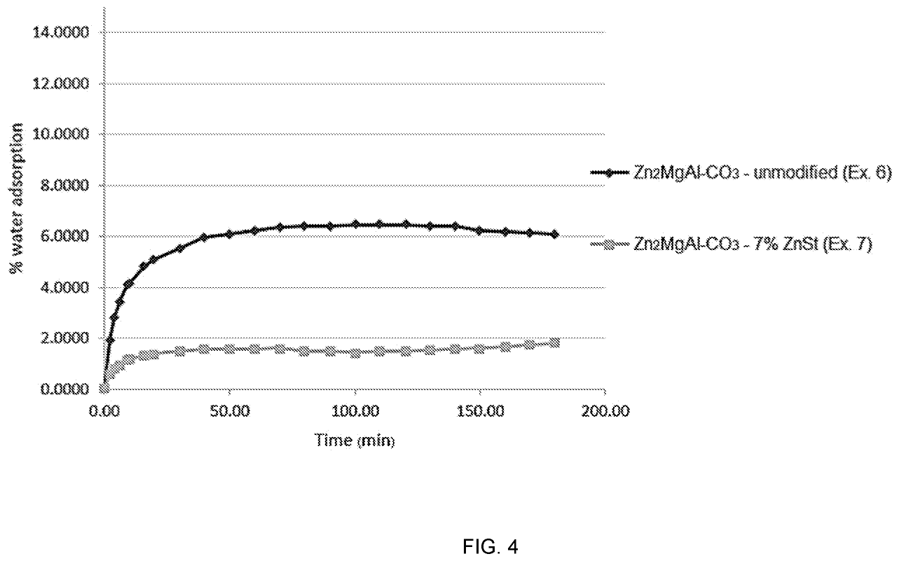

FIG. 4 shows the percentage water uptake of Examples 6 and 7 at various time points after exposure to RH60 at 25° C.

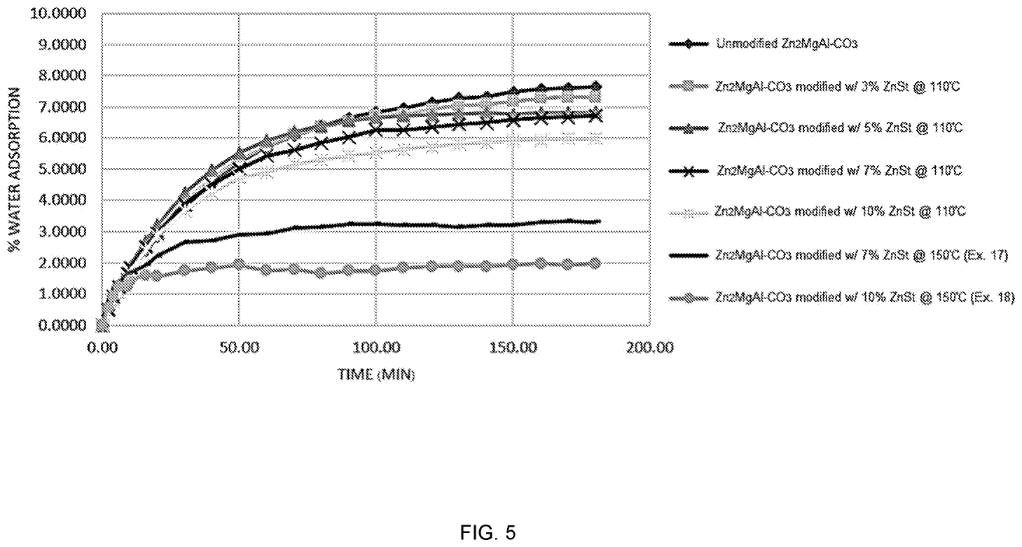

FIG. 5 shows the percentage water uptake at various time points after exposure to RH60 at 25° C. of Examples 17, 18 and Zn₂MgAl—CO₃ LDH samples (AMO treated; prepared according to method 2.2) modified with various loadings of zinc stearate at 110° C.

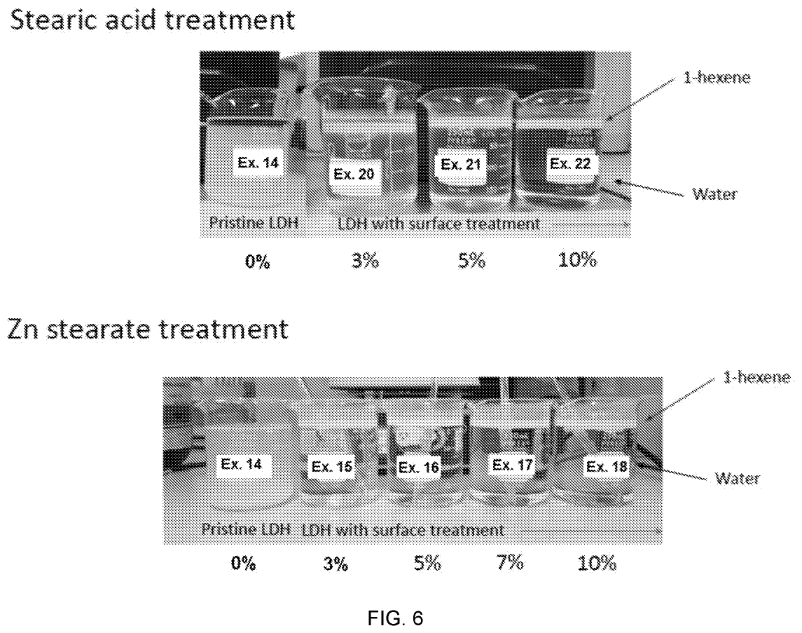

FIG. 6 shows pictures of the water/oil compatibility tests carried out on unmodified Zn₂MgAl—CO₃ LDH (Example 14) and Zn₂MgAl—CO₃ LDH modified with various amounts of stearic acid (Examples 20-22) or zinc stearate (Examples 15-18).

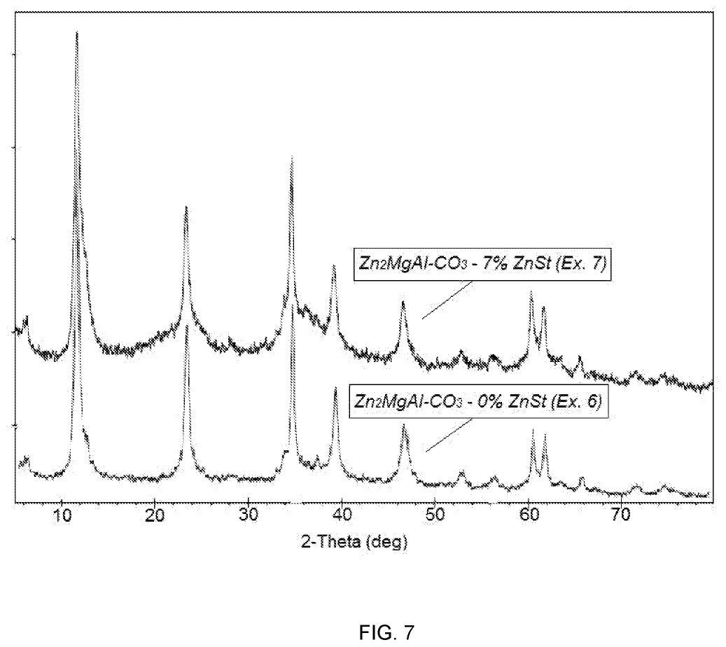

FIG. 7 shows overlaid X-Ray Diffractograms for unmodified Zn₂MgAl—CO₃ LDH (Example 6) and Zn₂MgAl—CO₃ LDH modified with 7% zinc stearate (Example 7).

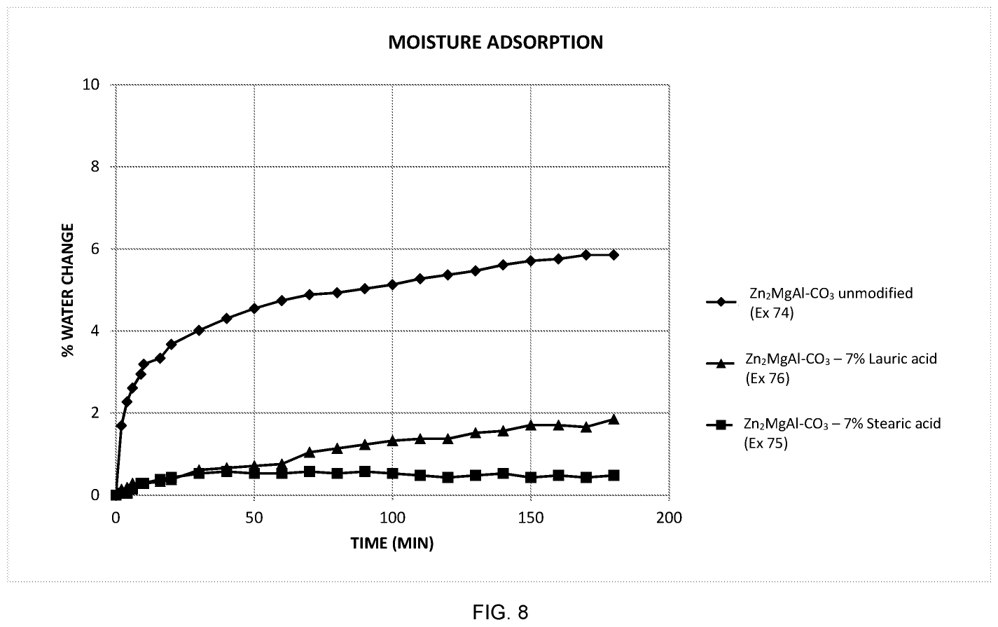

FIG. 8 shows the percentage water uptake of Examples 74, 76 and 75 at various time points after exposure to RH60 at 25° C.

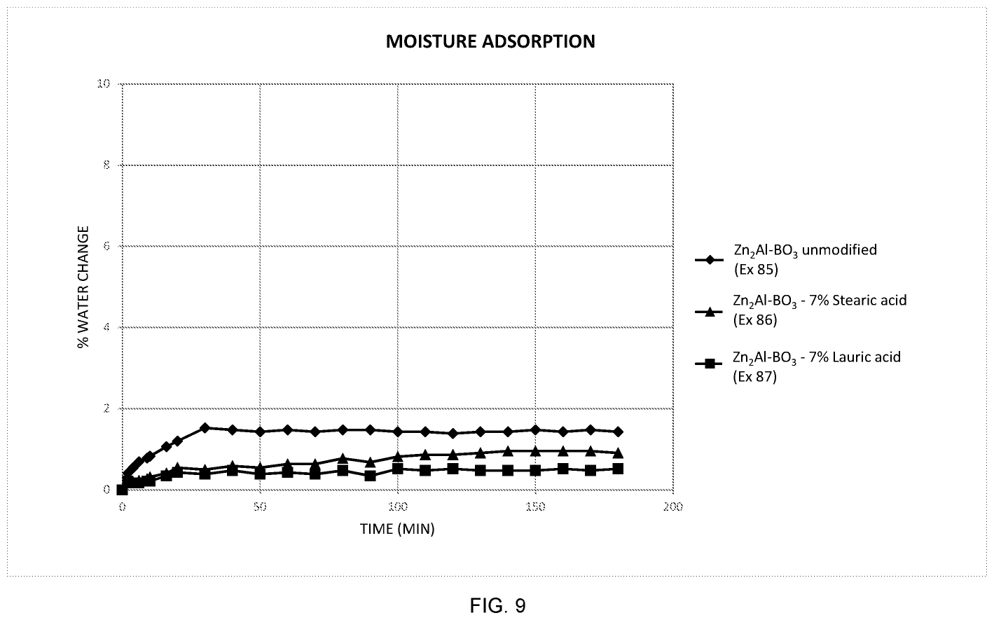

FIG. 9 shows the percentage water uptake of Examples 85, 86 and 87 at various time points after exposure to RH60 at 25° C.

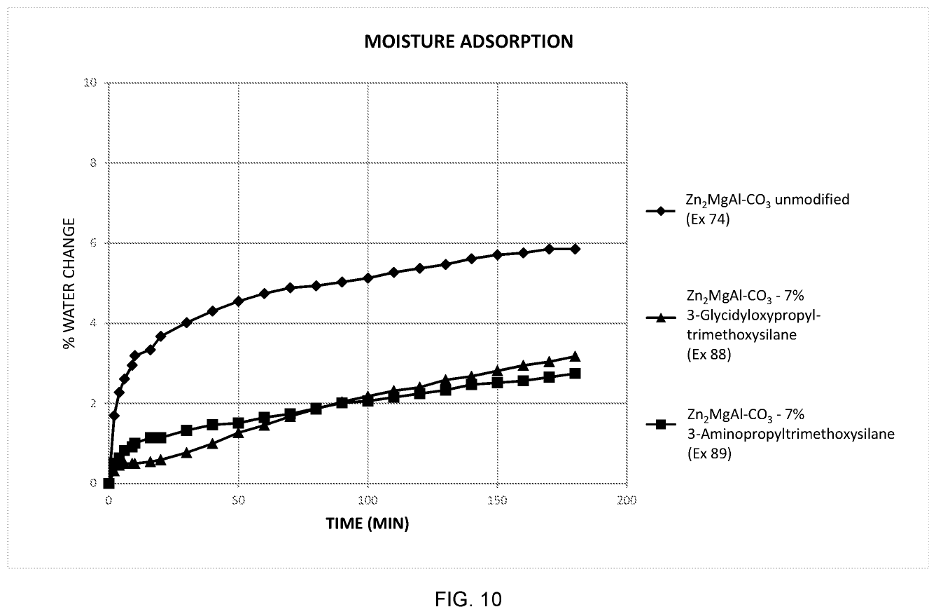

FIG. 10 shows the percentage water uptake of Examples 74, 88 and 89 at various time points after exposure to RH60 at 25° C.

The abbreviations used in the below examples and tables have the following meanings:

Mg₃Al—CO₃: [Mg_{0.75}Al_{0.25}(OH)₂][CO₃]_{0.125}.bH₂O;
Zn₂MgAl—CO₃: [(Mg_{0.33}Zn_{0.66})_{0.75}Al_{0.25}(OH)₂][CO₃]_{0.125}.bH₂O.
Zn₂Al—NO₃: [Zn_{0.66}Al_{0.33}(OH)₂][NO₃]_{0.31}.bH₂O.
Zn₂Al—PO₄: [Zn_{0.66}Al_{0.33}(OH)₂][PO₄]_{0.10}.bH₂O.
Zn₂Al—BO₃: [Zn_{0.66}Al_{0.33}(OH)₂][BO₃]_{0.31}.bH₂O.

### Part I Example 1—Preparation of LDHs (Mg₃Al—Co₃)

### Method 1.1

Mg(NO₃)₂.6H₂O (11.535 kg) and Al(NO₃)₃.9H₂O (5.624 kg) were dissolved in 42 L of deionized water (Solution A). A second solution was made containing Na₂CO₃ (3.18 kg) and NaOH (3.84 kg) dissolved in 42 L of deionized water (Solution B). Solutions A and B were added together through mixing machine at the speed of 2,900 rpm and transfer to aging tank under a stirring speed of 40 rpm at 100° C. for 4 hours. The pH was controlled at 10. After 4 hours of ageing, the resulting slurry was filtered by filter press technique, the filter cake was washed with deionized water the pH of the washings was 7, dried by vacuum oven at 110° C. for 18 hours and ground to a powder.

### Method 1.2

A metal precursor solution was prepared by dissolving the Mg(NO₃)₂.6H₂O (4.904 kg) and Al(NO₃)₃.9H₂O (2.391 kg) in 8.5 L of deionized water. The metal precursor solution was added drop-wise with a drop rate of 645 ml/minute into 8.5 L of a 1.5 M Na₂CO₃ solution under a stirring speed of 800 rpm at room temperature. The system was kept at a constant pH 10 by using a 12 M NaOH solution. After 4 hours of ageing, the resulting slurry was filtered under vacuum, and the filter cake was washed with deionized water the pH of the washings was 7. The solid was then dried in a vacuum oven at 110° C. for 18 hours and ground to a powder.

### Example 2—Preparation of LDHs (Zn₂MgAl—Co₃)

### Method 2.1

Zn(NO₃)₂.6H₂O (8.919 kg), Mg(NO₃)₂.6H₂O (3.845 kg) and Al(NO₃)₃.9H₂O (5.624 kg) were dissolved in 42 L of deionized water (Solution A). A second solution was made containing Na₂CO₃ (3.18 kg) and NaOH (3.84 kg) dissolved in 42 L of deionized water (Solution B). Solutions A and B were added together through mixing machine at the speed of 2,900 rpm and transfer to aging tank under a stirring speed of 40 rpm at 100° C. for 4 hours. The pH was controlled at 10. After 4 hours of ageing, the resulting slurry was filtered by filter press technique, the filter cake was washed with deionized water the pH of the washings was 7, dried by vacuum oven at 110° C. for 18 hours and ground to a powder.

### Method 2.2

A metal precursor solution was prepared by dissolving Zn(NO₃)₂.6H₂O (3.793 kg), Mg(NO₃)₂.6H₂O (1.635 kg) and Al(NO₃)₃.9H₂O (2.391 kg) in 8.5 L of deionized water. The metal precursor solution was added drop-wise with a drop rate of 645 ml/minute into 8.5 L of a 1.5 M Na₂CO₃ solution under a stirring speed of 800 rpm at room temperature. The system was kept at a constant pH 10 by using a 12 M NaOH solution. After 4 hours of ageing, the resulting slurry was filtered under vacuum, and the filter cake was washed with deionized water the pH of the washings was 7. The solid was then dried in a vacuum oven at 110° C. for 18 hours and ground to a powder.

### Example 3—Preparation of AMO-LDHs

LDHs were prepared according to the methods described in Example 1 or Example 2, with the exception that after water washing of the filter cake, and prior to vacuum oven drying, the water-wet LDH was re-dispersed in ethanol for 1 hour at a stirring speed of 40 rpm and then filtered by vacuum filtration technique.

### Example 4—Modification of LDHs/AMO-LDHs with Zinc Stearate/Stearic Acid

### Example 4.1—Zinc Stearate

LDHs or AMO-LDHs prepared according to the methods described in Examples 1 to 3, were heated at 150° C. for 4 hours and then mixed with zinc stearate (for amounts see Table 1) at a mixing speed of 600 rpm and a temperature of 150° C. for 30 minutes to obtain modified LDH.

### Example 4.2—Stearic Acid

LDHs or AMO-LDHs prepared according to the methods described in Examples 1 to 3, were heated at 150° C. for 4 hours and then mixed with stearic acid (for amounts see Table 1) at a mixing speed of 600 rpm and a temperature of 100° C. for 30 minutes to obtain modified LDH.

### Example 5—Modification of LDHs/AMO-LDHs with Phthalate Modifiers

LDHs or AMO-LDHs prepared according to the methods described in Examples 1 to 3, were heated at 150° C. for 4 hours and then mixed with either dioctyl terephthalate—DOTP, diisodecyl phthalate—DIDP, diisononyl phthalate—DINP, dioctyl phthalate—DOP, or dibutyl phthalate—DBP (7% w/w loading; equivalent to 7 g of modifier per 100 g of LDH powder) at a mixing speed of 600 rpm and a temperature of 100° C. for 30 minutes to obtain modified LDH.

TABLE 1

| | | | | | Modifier |
|---|---|---|---|---|---|
| | | | AMO | | Loading |
| Example | LDH | Method | treated? | Modifier | (% w/w) |
| 6 | Zn₂MgAl—CO₃ | 2.1 | No | None | — |
| 7 | Zn₂MgAl—CO₃ | 2.1 | No | Zinc | 7 |
| | | | | stearate | |
| 8 | Zn₂MgAl—CO₃ | 2.1 | No | Zinc | 10 |
| | | | | stearate | |
| 9 | Zn₂MgAl—CO₃ | 2.1 | No | Zinc | 15 |
| | | | | stearate | |
| 10 | Zn₂MgAl—CO₃ | 2.1 | Yes | None | — |
| 11 | Zn₂MgAl—CO₃ | 2.1 | Yes | Zinc | 7 |
| | | | | stearate | |
| 12 | Zn₂MgAl—CO₃ | 2.1 | Yes | Zinc | 10 |
| | | | | stearate | |
| 13 | Zn₂MgAl—CO₃ | 2.1 | Yes | Zinc | 15 |
| | | | | stearate | |
| 14 | Zn₂MgAl—CO₃ | 2.2 | Yes | None | — |
| 15 | Zn₂MgAl—CO₃ | 2.2 | Yes | Zinc | 3 |
| | | | | stearate | |
| 16 | Zn₂MgAl—CO₃ | 2.2 | Yes | Zinc | 5 |
| | | | | stearate | |
| 17 | Zn₂MgAl—CO₃ | 2.2 | Yes | Zinc | 7 |
| | | | | stearate | |
| 18 | Zn₂MgAl—CO₃ | 2.2 | Yes | Zinc | 10 |
| | | | | stearate | |
| 19 | Zn₂MgAl—CO₃ | 2.2 | Yes | Zinc | 15 |
| | | | | stearate | |
| 20 | Zn₂MgAl—CO₃ | 2.2 | Yes | Stearic | 3 |
| | | | | acid | |
| 21 | Zn₂MgAl—CO₃ | 2.2 | Yes | Stearic | 5 |
| | | | | acid | |
| 22 | Zn₂MgAl—CO₃ | 2.2 | Yes | Stearic | 10 |
| | | | | acid | |
| 23 | Mg₃Al—CO₃ | 1.1 | No | None | — |
| 24 | Mg₃Al—CO₃ | 1.1 | No | Zinc | 7 |
| | | | | stearate | |
| 25 | Mg₃Al—CO₃ | 1.1 | No | Zinc | 10 |
| | | | | stearate | |
| 26 | Mg₃Al—CO₃ | 1.1 | No | Zinc | 15 |
| | | | | stearate | |
| 27 | Mg₃Al—CO₃ | 1.1 | Yes | None | — |
| 28 | Mg₃Al—CO₃ | 1.1 | Yes | Zinc | 7 |
| | | | | stearate | |
| 29 | Mg₃Al—CO₃ | 1.1 | Yes | Zinc | 10 |
| | | | | stearate | |
| 30 | Mg₃Al—CO₃ | 1.1 | Yes | Zinc | 15 |
| | | | | stearate | |
| 31 | Mg₃Al—CO₃ | 1.2 | No | None | — |
| 32 | Mg₃Al—COₛ | 1.2 | No | Zinc | 15 |
| | | | | stearate | |
| 33 | Mg₂Al—CO₃^{a} | — | No | None | — |
| 34 | Mg₂Al—CO₃^{a} | — | No | Zinc | 7 |
| | | | | stearate | |
| 35 | Mg₂Al—CO₃^{a} | — | No | Zinc | 15 |
| | | | | stearate | |
| 36 | Zn₂MgAl—CO₃ | 2.2 | No | DOTP | 1 |
| 37 | Zn₂MgAl—CO₃ | 2.2 | No | DBP | 7 |
| 38 | Zn₂MgAl—CO₃ | 2.2 | No | DOP | 7 |
| 39 | Zn₂MgAl—CO₃ | 2.2 | No | DIDP | 7 |
| 40 | Zn₂MgAl—CO₃ | 2.2 | No | DINP | 7 |

^{a}Mg₂Al—CO₃ obtained from commercial source

### Scale-Up of LDH/AMO-LDH Modification

The modifications according to Examples 4 & 5 were carried out on a 5-15 g scale in round-bottomed flasks. The zinc stearate modifications of Zn₂MgAl—CO₃ were repeated on (i) a 1 kg scale using an internal mixer at a speed of 800 rpm at 150° C. for 30 min, and on (ii) a 5-10 kg scale in a Labo powder mixer at a speed of 1200 rpm at 150° C. for 30 min.

### Characterisation of Modified LDHs

### Density Measurements

Samples were heated at 110° C. for at least 3 hr to remove any excess moisture and then stored in a desiccator prior to density measurement. Sample was added to a pre-weighed 100 ml measuring cylinder, to a volume of 100 ml and then the mass of the cylinder+sample was weighed. The mass of the sample was determined by subtracting the mass of the cylinder. Bulk density (g/ml) was calculated as:

Bulk density=mass of sample (g)/100 (ml).

The measuring cylinder containing sample was then placed in an AutoTap machine (Quantachrome, Model AT-6-220-50) and subjected to tapping to reduce the volume. The tapped density (g/ml) was calculated as:

Tapped density=mass of sample (g)/volume of sample after tapping (ml).

### Moisture Uptake Capacity

Pre-weighed samples were exposed at 60% (+/−5%) relative humidity, 20° C. The percentage weight change for samples after an exposure time T were calculated by:

% weight change=(wt after exposure (T mins)−wt pre-exposure)×100.

### Hydrophobicity

### Method A: Water/Oil Compatibility

Samples were added into a mixture of 200 ml of water/20 ml of 1-hexene. FIG. 6 shows exemplary water/oil compatibility tests. The compatibility of LDH sample in 1-hexene was evaluated by eye; good compatibility in the oil phase correlated with the sample being predominantly present in that phase; poor compatibility correlated with the sample being predominantly present in the aqueous phase.

### Method B: Contact Angle Measurement

LDH samples were prepared as flat pellets with 2 cm diameter. A water droplet (10 μl) was injected by Teflon type syringe and dropped onto the LDH pellet surface. The contact angle of the water droplet on the pellet surface was measured by Contact Angle Meter DM-701 (FAMAS). Triplet measurements were made and the average of the three measurements taken.

TABLE 2

| | Bulk | Tapped | Surface | | Average |
|---|---|---|---|---|---|
| | density | density | area | Oil phase | Contact |
| Example | (g/ml) | (g/ml) | (m²/g) | compatibility | Angle (°) |
| 6 | 0.39 | 0.61 | 37.7 | Poor | 18.0 |
| 7 | 0.50 | 0.74 | 36.3 | Good | 122 |
| 8 | 0.53 | 0.79 | 23.7 | Good | 132 |
| 9 | 0.55 | 0.78 | 27.0 | Good | 123 |
| 10 | 0.32 | 0.44 | 70.6 | Poor | 17.9 |
| 11 | 0.32 | 0.50 | 53.3 | Good | 123 |
| 12 | 0.33 | 0.52 | 47.6 | Good | 126 |
| 13 | 0.35 | 0.55 | 39.9 | Good | 125 |
| 14 | 0.16 | 0.23 | 84.9 | Poor | 23.2 |
| 15 | — | — | — | Good | — |
| 16 | 0.19 | — | 75.4 | Good | 104 |
| 17 | 0.20 | — | 54.7 | Good | 106 |
| 13 | 0.21 | — | 58.9 | Good | 108 |
| 19 | 0.25 | 0.33 | 64.8 | Good | 109 |
| 20 | — | — | — | Partial | — |
| 21 | — | — | — | Good | — |
| 22 | — | — | — | Good | — |
| 23 | 0.46 | 0.69 | 77 | Poor | — |
| 24 | 0.61 | 0.92 | 53 | Good | — |
| 25 | 0.65 | 0.91 | — | Good | — |
| 26 | 0.71 | 0.94 | 35 | Good | — |
| 27 | 0.28 | 0.46 | 105 | Poor | — |
| 28 | 0.33 | 0.57 | 94 | Good | — |
| 29 | 0.35 | 0.58 | — | Good | — |
| 30 | 0.34 | 0.60 | 76 | Good | — |
| 31 | 0.41 | 0.62 | 68.4 | Poor | — |
| 32 | 0.52 | 0.84 | 35.1 | Good | — |
| 33 | 0.35 | 0.52 | 20.4 | Poor | 106 |
| 34 | 0.43 | 0.68 | 15.6 | Good | 113 |
| 35 | 0.42 | 0.73 | 8.8 | Good | 121 |
| 36 | — | — | — | — | 104 |
| 37 | — | — | — | — | 104 |
| 38 | — | — | — | — | 115 |
| 39 | — | — | — | — | 116 |
| 40 | — | — | — | — | 132 |

For a given LDH, the data in Table 2 shows that surface modification was generally found to increase the bulk and tapped densities, reduce the surface area and increase the hydrophobicity as seen by improved oil phase compatibility and increased average contact angle.

FIG. 2 shows the moisture uptake capacity at 60% RH, 25° C. for Examples 14 (Zn₂MgAl—CO₃; 0% Zn stearate), 17 (Zn₂MgAl—CO₃; 7% Zn stearate), 18 (Zn₂MgAl—CO₃; 10% Zn stearate) and 19 (Zn₂MgAl—CO₃; 15% Zn stearate) measured over 180 minutes. With increasing zinc stearate loading, the moisture uptake capacity is reduced from 8% for the unmodified LDH, to 0.5% for the modified LDH with a 15% loading of zinc stearate.

FIG. 3 shows the overlaid DTA scans for Examples 14 (Zn₂MgAl—CO₃; 0% Zn stearate), 16 (Zn₂MgAl—CO₃; 5% Zn stearate), 17 (Zn₂MgAl—CO₃; 7% Zn stearate), 18 (Zn₂MgAl—CO₃; 10% Zn stearate) and 19 (Zn₂MgAl—CO₃; 15% Zn stearate) heated from ambient temperature to 800° C. Prior to DTA analysis, the samples had been exposed to 60% RH for 3 hours at 25° C. With increasing zinc stearate loading, the amount of water in the sample (outerlayer and innerlayer water) is reduced. Increased stearate decomposition in the range 400-500° C. was observed as the loading of zinc stearate in the sample increased, indicating that the modifier is successfully incorporated into the LDH.

FIG. 4 shows the moisture uptake capacity at 60% RH, 25° C. for Examples 6 (Zn₂MgAl—CO₃; 0% Zn stearate) and 7 (Zn₂MgAl—CO₃; 7% Zn stearate) measured over 180 minutes. Zinc stearate modification reduces the moisture uptake from 6% to approx. 2%.

FIG. 5 shows moisture uptake capacity at 60% RH, 25° C. measured over 180 minutes for various zinc stearate modified Zn₂MgAl—CO₃ samples. The samples prepared by carrying out the modifier coating step at 150° C. (Examples 17 & 18) had reduced water uptake capacity, compared to the analogous samples prepared by carrying out the modifier coating step at 110° C.

FIG. 6 shows the partition between water and 1-hexene for unmodified AMO-Zn₂MgAl—CO₃ (Example 14) and samples modified with stearic acid (Examples 20-22) and zinc stearate (Examples 15-18). The unmodified LDH was predominantly dispersed in the aqueous phase, while after modification the samples showed much greater propensity to partition into the 1-hexene phase. At the same loading, zinc stearate performed better than stearic acid (e.g. Example 15—3% zinc stearate compared with Example 20—3% stearic acid).

FIG. 7 shows overlaid XRD plots for unmodified Zn₂MgAl—CO₃ (Example 6) and Zn₂MgAl—CO₃ modified with 7% zinc stearate (Example 7). The XRD patterns are substantially identical, indicating that the modifier is to be found on the LDH surface, not intercalated within the LDH structure.

### Preparation of PVC Composites

PVC composite materials were prepared by mixing 100 parts by weight of PVC resin, 4 parts by weight of tribasic lead sulphate, 20 parts by weight of 1,2-benzenedicarboxylic acid diisodecyl ester, 10 parts by weight of tris(2-ethylhexyl) trimellitate, 5 parts by weight of chlorinated paraffin oil, 5 parts by weight of epoxidized soybean oil, 50 parts by weight of CaCO₃, 0.2 parts by weight of epoxidized PE wax, 3 parts by weight of antimony trioxide, 2 parts by weight of silicon dioxide, 1 parts by weight of acrylic processing aid, and the LDH examples as prepared (see Table 3 for LDH amounts, expressed as parts per hundred resin (phr)—e.g. 7 phr=7 parts LDH per hundred parts PVC resin by weight) in a hot melt mixer, HAAKE™ PolyLab™ OS system HAAKE Model at 180° C. for 3 minutes under a mixing speed of 60 rpm.

### Characterisation of PVC Composites

### Colour Stability

Colour stability of prepared PVC composites were evaluated after extrusion by spectrophotometer CM-3600A (Konica Minolta). PVC composites were compression molded into 11×11 cm² square plaques of uniform thickness (approximately 3 mm) for measurement of whiteness index (WI) and yellowness index (YI) by spectrophotometer.

### Voids

Voids of prepared PVC composites were assessed by evaluating the number of voids on a 3 mm cross-section of the PVC composites sample formed as an extruded strand, using scanning electron microscope (SEM) imaging. The samples were scanned with an accelerating voltage capacity of 1-20 k eV, at a working distance of 10 mm and a magnification at 30× at 10 kV providing a resolution of 500 μm.

The number of voids was scored according to the following criteria:
0=no voids;
1=less than 5 voids & smooth surface;
2=5-10 voids & smooth surface;
3=10-20 voids & smooth surface;
4=10-20 voids & rough surface;
5=greater than 20 voids & rough surface.

### Mechanical Properties

The tensile strength and elongation at break of the PVC composites were tested according to the IEC60811-1-1 standard.

The properties of the prepared PVC composite materials are summarized in Table 3. The composites containing modified LDHs prepared according to the invention, provide higher color stability (high value of WI and low value of YI) and lower voids in comparison with the comparable composites containing unmodified LDHs.

TABLE 3

| | | Amount | | | | Tensile | Elongation |
|---|---|---|---|---|---|---|---|
| | | LDH | | | | Strength | at break |
| Example | LDH | (phr) | Wl | Yl | Voids | (MPa) | (%) |
| 41 | 10 | 7 | 28.0 | 18.7 | 1 | 23 | 268 |
| 42 | 11 | 7 | 52.4 | 11.5 | 0 | 21.8 | 219 |
| 43 | 12 | 7 | 54.8 | 11.3 | 0 | 21.4 | 260 |
| 44 | 13 | 7 | 57.7 | 9.9 | 0 | 21.0 | 211 |
| 45 | 10 | 15 | 18.9 | 18.3 | 2 | 22.0 | 218 |
| 46 | 11 | 15 | 30.5 | 18.6 | 0 | 21.0 | 206 |
| 47 | 12 | 15 | 40.4 | 15.9 | 0 | 19.8 | 234 |
| 48 | 13 | 15 | 42.6 | 14.9 | 0 | 18.9 | 195 |
| 49 | 10 | 30 | −28.3 | 37 | 5 | 23.1 | 169 |
| 50 | 11 | 30 | 10.1 | 23.2 | 0 | 19.5 | 184 |
| 51 | 12 | 30 | 16.5 | 23.1 | 0 | 15.2 | 164 |
| 52 | 13 | 30 | 14.9 | 23.4 | 0 | 14.1 | 143 |
| 53 | 6 | 7 | 54.4 | 11.2 | 1 | 21.4 | 245 |
| 54 | 7 | 7 | 64.3 | 7.5 | 0 | 20.2 | 219 |
| 55 | 8 | 7 | 59.9 | 9.3 | 0 | 21.6 | 256 |
| 56 | 9 | 7 | 63.9 | 7.4 | 0 | 20.5 | 213 |
| 57 | 6 | 15 | 23.1 | 15.7 | 1 | 21.5 | 247 |
| 58 | 7 | 15 | 51.8 | 11.6 | 0 | 19.8 | 194 |
| 59 | 8 | 15 | 52.0 | 11.9 | 0 | 18.8 | 215 |
| 60 | 9 | 15 | 55.6 | 10.0 | 0 | 17.3 | 164 |
| 61 | 6 | 30 | −20.7 | 34.0 | 3 | 21.8 | 156 |
| 62 | 7 | 30 | 34.1 | 16.8 | 0 | 15.9 | 154 |
| 63 | 8 | 30 | 36.1 | 16.7 | 0 | 13.3 | 128 |
| 64 | 9 | 30 | 35.3 | 16.2 | 0 | 10.5 | 76 |
| 65 | 33 | 30 | −40.1 | 37.0 | 5 | — | — |
| 66 | 34 | 30 | 24.1 | 13.8 | 2 | — | — |
| 67 | 35 | 30 | 29.4 | 12.3 | 2 | — | — |
| 68 | none | — | 72.4 | 4.2 | — | 25.2 | 278 |

### Part II

### Example 69—Preparation of LDHs (Zn₂Al—NO₃)

Zn(NO₃)₂.6H₂O (11.141 kg) and Al(NO₃)₃.9H₂O (7.035 kg) were dissolved in 42 L of deionized water (Solution A). A second solution was made containing Na₂NO₃ (11.921 kg) and NaOH (3.38 kg) dissolved in 42 L of deionized water (Solution B). Solutions A and B were added together through mixing machine at the speed of 2,900 rpm and transfer to aging tank under a stirring speed of 40 rpm at 100° C. for 4 hours. The pH was controlled at 10. After 4 hours of ageing, the resulting slurry was filtered by filter press technique, the filter cake was washed with deionized water the pH of the washings was 7, dried by vacuum oven at 110° C. for 18 hours and ground to a powder.

### Example 70—Preparation of LDHs (Zn₂Al—PO₄)

Zn₂Al—PO₄ was obtained from a commercial source.

### Example 71—Preparation of LDHs (Zn₂Al—BO₃)

Zn(NO₃)₂.6H₂O (5.942 kg) and Al(NO₃)₃.9H₂O (3.752 kg) were dissolved in 40 L of deionized water (Solution A). A second solution was made containing Boric acid (4.55 kg) and NaOH (3.29 kg) dissolved in 57 L of deionized water (Solution B). Solutions A and B were added together through mixing machine at the speed of 2,900 rpm and transfer to aging tank under a stirring speed of 40 rpm at 100° C. for 4 hours. The pH was controlled at 9. After 4 hours of ageing, the resulting slurry was filtered by filter press technique, the filter cake was washed with deionized water the pH of the washings was 7, dried by vacuum oven at 110° C. for 18 hours and ground to a powder.

### Example 72—Modification of LDHs with Stearic Acid/Lauric Acid

### Stearic Acid

LDHs prepared according to the methods described in Example 2 (Method 2.1) or Example 71 were heated at 150° C. for 4 hours and then mixed with stearic acid (for amounts see Table 4) via physical mixing technique via mechanical force. Then, the mixed powder is transferred to round-bottom flask to mix at a speed of 700 rpm and a temperature of 100° C. for 30 min to obtain modified LDH.

### Lauric Acid

LDHs prepared according to the methods described in Example 2 (Method 2.1) or Example 71 were heated at 150° C. for 4 hours and then mixed with lauric acid (for amounts see Table 4) via physical mixing technique via mechanical force. Then, the mixed powder is transferred to round-bottom flask to mix at a speed of 700 rpm and a temperature of 70° C. for 30 min to obtain modified LDH.

### Example 73—Modification of LDHs with Silanes

### 3-Glycidyloxypropyltrimethoxysilane

LDHs prepared according to the methods described in Example 2 (Method 2.1) were heated at 150° C. for 4 hours and then mixed with 3-Glycidyloxypropyltrimethoxysilane (for amounts see Table 4) via physical mixing technique via mechanical force. Then, the mixed powder is transferred to round-bottom flask to mix at a speed of 700 rpm and a temperature of 60° C. for 30 min to obtain modified LDH.

### 3-Aminopropyltrimethoxysilane

LDHs prepared according to the methods described in Example 2 (Method 2.1) were heated at 150° C. for 4 hours and then mixed with 3-Aminopropyltrimethoxysilane (for amounts see Table 4) via physical mixing technique via mechanical force. Then, the mixed powder is transferred to round-bottom flask to mix at a speed of 700 rpm and a temperature of 60° C. for 30 min to obtain modified LDH.

TABLE 4

| | | | | | Modifier |
|---|---|---|---|---|---|
| | | | AMO | | Loading |
| Example | LDH | Method | treated? | Modifier | (% w/w) |
| 74 | Zn₂MgAl—CO₃ | 2.1 | No | None | — |
| 75 | Zn₂MgAl—CO₃ | 2.1 | No | Stearic acid | 7 |
| 76 | Zn₂MgAl—CO₃ | 2.1 | No | Lauric acid | 7 |
| 77 | Zn₂Al—NO₃ | — | No | None | — |
| 78 | Zn₂Al—NO₃ | — | No | Zinc stearate | 7 |
| 79 | Zn₂Al—PO₄ | — | No | None | — |
| 80 | Zn₂Al—PO₄ | — | No | Zinc stearate | 7 |
| 81 | Zn₂Al—BO₃ | — | No | None | — |
| 82 | Zn₂Al—BO₃ | — | No | Zinc stearate | 7 |
| 83 | Mg₂Al—CO₃^{a} | — | No | None | — |
| 84 | Mg₂Al—CO₃^{a} | — | No | Zinc stearate | 7 |
| 85 | Zn₂Al—BO₃ | — | No | None | — |
| 86 | Zn₂Al—BO₃ | — | No | Stearic acid | 7 |
| 87 | Zn₂Al—BO₃ | — | No | Lauric acid | 7 |
| 88 | Zn₂MgAl—CO₃ | 2.1 | No | 3-Glycidyloxypropyl- | 7 |
| | | | | trimethoxysilane | |
| 89 | Zn₂MgAl—CO₃ | 2.1 | No | 3-Aminopropyltri- | 7 |
| | | | | methoxysilane | |

Mg₂Al—CO₃^{a} was obtained from commercial source; Examples 75, 76, 88 and 89 in Table 4 were carried out on a 10 g scale (mass of LDH); Examples 78, 80, 82, 84, 86 and 87 in Table 4 were carried out on a 1 kg scale (mass of LDH)

### Characterisation of Modified LDHs

### Density Measurements

Samples were heated at 110° C. for at least 3 hr to remove any excess moisture and then stored in a desiccator prior to density measurement. Sample was added to a pre-weighed 100 ml measuring cylinder, to a volume of 100 ml and then the mass of the cylinder+sample was weighed. The mass of the sample was determined by subtracting the mass of the cylinder. Bulk density (g/ml) was calculated as:

Bulk density=mass of sample (g)/100 (ml).

The measuring cylinder containing sample was then placed in an AutoTap machine (Quantachrome, Model AT-6-220-50) and subjected to tapping to reduce the volume. The tapped density (g/ml) was calculated as:

Tapped density=mass of sample (g)/volume of sample after tapping (ml).

### Moisture Uptake Capacity

Pre-weighed samples were exposed at 60% (+/−5%) relative humidity, 20° C. The percentage weight change for samples after an exposure time T were calculated by:

% weight change=(wt after exposure (T mins)−wt pre-exposure)×100.

### Hydrophobicity

### Method A: Water/Oil Compatibility

Samples were added into a mixture of 200 ml of water/20 ml of 1-hexene. FIG. 6 shows exemplary water/oil compatibility tests. The compatibility of LDH sample in 1-hexene was evaluated by eye; good compatibility in the oil phase correlated with the sample being predominantly present in that phase; poor compatibility correlated with the sample being predominantly present in the aqueous phase.

### Method B: Contact Angle Measurement

LDH samples were prepared as flat pellets with 2 cm diameter. A water droplet (10 μl) was injected by Teflon type syringe and dropped onto the LDH pellet surface. The contact angle of the water droplet on the pellet surface was measured by Contact Angle Meter DM-701 (FAMAS). Triplet measurements were made and the average of the three measurements taken.

TABLE 5

| | Bulk | Tapped | Surface | | Average |
|---|---|---|---|---|---|
| | density | density | area | Oil phase | Contact |
| Example | (g/ml) | (g/ml) | (m²/g) | compatibility | Angle (°) |
| 74 | — | — | — | Poor | — |
| 75 | — | — | — | Good | 135.2 |
| 76 | — | — | — | Good | 138.2 |
| 77 | — | — | — | Poor | 8.5 |
| 78 | — | — | — | Good | 136.7 |
| 79 | 0.46 | 0.67 | — | Poor | 0 |
| 80 | 0.55 | 0.74 | — | Good | 135.3 |
| 81 | 0.22 | 0.33 | — | Poor | 0 |
| 82 | 0.30 | 0.48 | — | Good | 137.5 |
| 83 | 0.32 | 0.49 | — | Poor | 7.7 |
| 84 | 0.32 | 0.42 | — | Good | 135.1 |
| 85 | — | — | — | Poor | 0 |
| 86 | — | — | — | Good | 133.0 |
| 87 | — | — | — | Good | 122.3 |
| 88 | 0.32 | 0.50 | — | — | — |
| 89 | 0.30 | 0.43 | — | — | — |

Table 5 illustrates that the LDH modification process increases the hydrophobicity, bulk density and/or tapped density.

### Particle Size

As seen in Table 6 below, the particle size distribution D10, D50, D90 of the inventive modified LDHs (Examples 82, 86 and 87) are in the acceptable range (D10=0.5-1 micron/D50=1-3 micron/D90=2.5-6 micron) for use as an additive in polymer formulations that are processed via an extrusion technique (i.e. to achieve a good dispersion and a smooth surface), and are similar to those of the unmodified LDHs (Example 81 and 85). Therefore, the LDH modification process does not lead to the formation of aggregates.

TABLE 6

| | Particle size | Particle size | Particle size |
|---|---|---|---|
| | distribution | distribution | distribution |
| Example | (D10, μm) | (D50, μm) | (D90, μm) |
| 81 | 0.68 | 1.69 | 5.77 |
| 82 | 0.79 | 2.33 | 5.60 |
| 85 | 0.68 | 1.69 | 5.77 |
| 86 | 0.66 | 1.46 | 3.83 |
| 87 | 0.71 | 1.89 | 5.58 |

1. A process for forming a modified layered double hydroxide comprising the steps of:
a) providing a layered double hydroxide;
b) heating the layered double hydroxide to 110-200° C.; and
c) mixing the thermally-treated layered double hydroxide of step b) with a modifier, wherein the mixing is conducted in the presence of less than or equal to 50% by weight of a solvent, relative to the total weight of the layered double hydroxide and the modifier.

2. The process according to claim 1, wherein the modifier is selected from the group consisting of fatty acids, fatty acid salts, sulfate modifiers, phosphonate modifiers, phthalate modifiers and organosilane modifiers.

3. The process according to claim 2, wherein the modifier is selected from the group consisting of:
stearic acid, lauric acid, palmitic acid, arachidic acid, maleic acid and oleic acid;
metal salts of stearic acid, lauric acid, palmitic acid, arachidic acid, maleic acid and oleic acid;
sodium dodecyl sulfate;
sodium octadecyl phosphonate;
dioctyl terephthalate, diisodecyl phthalate, diisononyl phthalate, dioctyl phthalate and dibutyl phthalate; and
trimethoxypropylsilane, trimethoxyoctylsilane, (3-glycidyloxypropyl)-trimethoxysilane and (3-aminopropyl)triethoxysilane.

4. The process according to claim 3, wherein the modifier is lithium stearate, zinc stearate, magnesium stearate, calcium stearate or sodium stearate.

5. The process according to claim 4, wherein the modifier is zinc stearate.

6. The process according to claim 1, wherein the layered double hydroxide provided in step a) is of formula (TB):
[M^{z+}₁₋ₓM′^{y+}ₓ(OH)₂]^{a+}(Xⁿ⁻)ₘ.bH₂O.c(L) (TB)
wherein
M is at least one charged metal cation;
M′ is at least one charged metal cation different from M;
z is 1 or 2;
y is 3 or 4;
0<x<0.9;
0<b≤10;
0<c≤10;
X is at least one anion;
n is the charge on anion(s) X;
a is equal to z(1−x)+xy−2;
m≥a/n; and
L is an organic solvent capable of hydrogen-bonding to water.

7. The process according to claim 1, wherein the layered double hydroxide is a Zn/Al, Mg/Al, Mg,Zn/Al, Mg/Al,Sn, Ca/Al, Ni/Ti or Cu/Al layered double hydroxide.

8. The process according to claim 6, wherein X is an anion selected from at least one of halide, inorganic oxyanion, and an organic anion (e.g. an anionic surfactant, an anionic chromophore or an anionic UV absorber).

9. The process according to claim 8, wherein the inorganic oxyanion is carbonate, bicarbonate, hydrogenphosphate, dihydrogenphosphate, nitrite, borate, nitrate, sulphate or phosphate or a mixture of two or more thereof.

10. The process according to claim 1, wherein in step b) the layered double hydroxide is heated to 130-180° C.

11. The process according to claim 1, wherein in step c) the mixing is conducted in the presence of less than or equal to 10% by weight of a solvent, relative to the total weight of the layered double hydroxide and the modifier.

12. The process according to claim 1, wherein the quantity of the modifier used in step c) is 1-25% by weight relative to the weight of the layered double hydroxide.

13. The process according to claim 1, wherein in step c) the mixing takes place at 60-270° C.

14. A modified layer double hydroxide obtainable by a process according to claim 1.

15. A composite material comprising a modified layer double hydroxide according to claim 14, dispersed throughout a polymer.
